(19) United States
(12) Patent Application Publication
(10) Pub. No.: US 2025/0391249 A1
(43) Pub. Date: Dec. 25, 2025

(54) SYNCHRONIZING ONLINE GAMING WITH SECURE TRANSACTIONS AND REAL-TIME REQUEST MANAGEMENT

(71) Applicant: Ralph Antony SCHULE, Las Vegas, NV (US)

(72) Inventor: Ralph Antony SCHULE, Las Vegas, NV (US)

(21) Appl. No.: 19/310,918

(22) Filed: Aug. 26, 2025

Related U.S. Application Data
(63) Continuation-in-part of application No. 17/460,251, filed on Aug. 29, 2021.

(51) Int. Cl. G07F 17/32; G06F 7/58; G06Q 20/36

(52) U.S. Cl. CPC G07F 17/3269; G06F 7/588; G06Q 20/36; G07F 17/3213; G07F 17/323; G07F 17/3293; G06Q 2220/00

(57) ABSTRACT

Methods, systems, and devices for online gaming a wager accumulation game with secure transactions and real-time request management are described. In some implementations, a game clock of a client device may be synchronized with a server clock by performing a ping-pong process to compute round-trip time and adjust timestamps for client requests. The system may process client requests by validating adjusted timestamps, queuing the requests based on a first-come, first-served principle, and prioritizing the requests in real-time. A wallet associated with the client may be managed by pre-allocating funds for a game session, updating the wallet based on game outcomes, and recording transactions in an unalterable ledger. Cards for gameplay may be distributed by generating random numbers through a cryptographically secure random number generator, and game states may be updated based on the distributed cards.

### CROSS REFERENCE TO RELATED APPLICATIONS

The present Application for Patent is a Continuation In Part of US 17/460,251, filed on Aug. 29, 2021, claiming priority of US 63/072,218 filed on Aug. 30, 2020, which are hereby incorporated by reference in their entirety.

### FIELD OF TECHNOLOGY

The present disclosure relates generally to database systems and data processing, and more specifically to synchronizing online gaming with secure transactions and real-time request management.

### BACKGROUND

Online gaming platforms may operate within a field where players participate in games remotely using internet-connected devices such as smartphones, tablets, or computers. These platforms may utilize server-client architectures to facilitate gameplay, with servers managing game logic and clients providing user interfaces. Multi-player games may involve real-time interactions among players, requiring systems to handle simultaneous actions and maintain synchronization across devices. Random number generation methods may be employed for tasks such as card distribution, ensuring unpredictability in gameplay outcomes. Wallet management systems may be used to handle in-game transactions, allowing players to fund their accounts and manage wagers. Transaction records may be maintained to track financial activities and game progress.

### SUMMARY

The described techniques relate to improved methods, systems, devices, and apparatuses for synchronizing online gaming with secure transactions and real-time request management. Some implementations may introduce a server-client architecture designed to address the challenges of real-time synchronization, secure transactions, and fair prioritization in online gaming environments. The server may incorporate a synchronization component that utilizes a Ping-Pong process to align client game clocks with the server clock, ensuring accurate timestamps for all user actions. Cryptographically Secure Pseudo Random Number Generators may be employed for card distribution, guaranteeing unbiased and unpredictable outcomes. A request management system may process user actions based on adjusted timestamps, prioritizing requests in real-time using first-come, first-served and first-in, first-out principles. This may ensure fairness and prevent fraudulent manipulation of timestamps.

Some implementations may further integrate a wallet management system that pre-allocates funds for the entire game duration, preventing overspending and ensuring predictable financial commitments for players. Transactions may be secured through a token-based system that includes unique identifiers for users, tables, and wallets, with all data recorded in an unalterable ledger, such as a private blockchain. This ledger may enable secure, auditable transactions and facilitate retrospective reconstruction of game events. By combining synchronized game clocks, cryptographically secure random number generation, and a robust request management system, some implementations may provide a scalable and secure solution for modern online gaming platforms.

A method for online gaming a wager accumulation game with multiple rounds, with secure transactions and real-time request management, between a client device and a server, the client device comprising a parameterized animation bank is described. The method may include the client device sending a request among joining, exiting and partnering requests to the server. The method may include synchronizing a game clock of the client device with a server clock by performing a ping-pong process to compute round-trip time and adjust timestamps for client requests. The method may include the client device timestamping the request by a time provided by the game clock. The method may include timestamping the request by an adjusted timestamp corrected by round-trip time upon receipt by the server. The method may include processing requests by validating adjusted timestamps, queuing the requests based on a first-come, first-served principle, and prioritizing the requests in real-time according to the adjusted timestamps. The method may include managing a wallet associated with a client by putting on hold pre-allocated funds for a game session, updating the wallet based on game outcomes, and recording transactions in an unalterable ledger. The method may include distributing card for one of the multiple rounds from a virtual card deck comprising X build cards and H half pot cards by generating random numbers through a cryptographically secure random number generator and updating a game state based on distributed cards. The method may include generating animation parameters and distributing the animation parameters to the client device for rendering game animations locally by transmitting data strings representing a card distribution sequence and round outcomes, rendering an animation on the client device by selecting a parameterized animation from the parameterized animation bank and playing the parameterized animation according to the animation parameters.

A system configured for online gaming a wager accumulation game with secure transactions and real-time request management is described. The system may include a processor and memory coupled with the processor. The system may include instructions stored in the memory and executable by the processor to cause the system to synchronize a game clock of a client device with a server clock by performing a ping-pong process to compute round-trip time and adjust timestamps for client requests. The system may include instructions to process client requests by validating adjusted timestamps, queuing the requests based on a first-come, first-served principle, and prioritizing the requests in real-time according to the adjusted timestamps. The system may include instructions to manage a wallet associated with a client by pre-allocating funds for a game session, updating the wallet based on game outcomes, and recording transactions in an unalterable ledger. The system may include instructions to distribute cards for gameplay by generating random numbers through a cryptographically secure random number generator and updating game states based on distributed cards.

A non-transitory computer-readable medium storing code for online gaming a wager accumulation game with secure transactions and real-time request management is described. The code may include instructions executable by a processor to synchronize a game clock of a client device with a server clock by performing a ping-pong process to compute round-trip time and adjust timestamps for client requests. The code may include instructions executable by a processor to process client requests by validating adjusted timestamps, queuing the requests based on a first-come, first-served principle, and prioritizing the requests in real-time according to the adjusted timestamps. The code may include instructions executable by a processor to manage a wallet associated with a client by pre-allocating funds for a game session, updating the wallet based on game outcomes, and recording transactions in an unalterable ledger. The code may include instructions executable by a processor to distribute cards for gameplay by generating random numbers through a cryptographically secure random number generator and updating game states based on distributed cards.

### BRIEF DESCRIPTION OF THE DRAWINGS

FIG. 1 illustrates an example of a system for information processing configured for synchronizing online gaming with secure transactions and real-time request management in accordance with aspects of the present disclosure.

FIG. 2 shows a physical casino game board adapted to a wager accumulation game some features of which may be simulated in online gaming with secure transactions and real-time request management in accordance with various aspects of the present disclosure.

FIG. 3 shows client-server architecture which supports techniques for synchronizing online gaming with secure transactions and real-time request management in accordance with various aspects of the present disclosure.

FIG. 4 illustrates a game engine flowchart that supports techniques for synchronizing online gaming with secure transactions and real-time request management in accordance with various aspects of the present disclosure.

FIG. 5 illustrates a game setup flowchart that supports techniques for synchronizing online gaming with secure transactions and real-time request management in accordance with various aspects of the present disclosure.

FIG. 6 illustrates a seats configuration flowchart that supports techniques for synchronizing online gaming with secure transactions and real-time request management in accordance with various aspects of the present disclosure.

FIG. 7 illustrates a joining request flowchart that supports techniques for synchronizing online gaming with secure transactions and real-time request management in accordance with various aspects of the present disclosure.

FIG. 8 illustrates a decision-making flowchart that supports techniques for synchronizing online gaming with secure transactions and real-time request management in accordance with various aspects of the present disclosure.

FIG. 9 illustrates a partnering request flowchart that supports techniques for synchronizing online gaming with secure transactions and real-time request management in accordance with various aspects of the present disclosure.

FIG. 10 illustrates an advantage play flowchart that supports techniques for synchronizing online gaming with secure transactions and real-time request management in accordance with various aspects of the present disclosure.

FIG. 11 shows game lobby interface which supports techniques for synchronizing online gaming with secure transactions and real-time request management in accordance with various aspects of the present disclosure.

FIG. 12 shows gaming interface illustration which supports techniques for synchronizing online gaming with secure transactions and real-time request management in accordance with various aspects of the present disclosure.

FIG. 13 illustrates an example of a process flow for synchronizing online gaming with secure transactions and real-time request management in accordance with various aspects of the present disclosure.

FIG. 14 shows a diagram of a system including a device for synchronizing online gaming with secure transactions and real-time request management in accordance with various aspects of the present disclosure.

FIG. 15 shows a flowchart illustrating a method for synchronizing online gaming with secure transactions and real-time request management in accordance with various aspects of the present disclosure.

FIG. 16 shows a flowchart illustrating a method for synchronizing online gaming with secure transactions and real-time request management in accordance with various aspects of the present disclosure.

### DETAILED DESCRIPTION

Methods, systems, devices, and apparatuses for synchronizing online gaming with secure transactions and real-time request management are disclosed. In some examples, conventional online gaming systems may face significant challenges in ensuring real-time synchronization, secure transactions, and fair prioritization of user actions. Server-client architectures may struggle with latency issues, leading to discrepancies between server and client clocks, which may compromise the integrity of time-sensitive actions. Random number generation methods used for card distribution may lack cryptographic security, increasing the risk of predictable outcomes and unfair gameplay. Wallet management systems may frequently fail to pre-allocate funds for specific game scenarios, exposing players to overspending risks and complicating transaction tracking. Furthermore, centralized transaction records may be prone to tampering and lack transparency, making retrospective audits unreliable. Request management systems in multi-player games may often fail to prioritize user actions effectively, resulting in delays and unfair treatment of players. These shortcomings may hinder the scalability, security, and fairness of online gaming platforms, necessitating a robust solution to address these issues.

In some implementations, a system may provide a server-client architecture optimized for online gaming, where the server may act as the authoritative component responsible for managing game logic, processing user actions, and hosting the core game engine. The client may function as the user interface, rendering animations and controls without directly processing game logic. To achieve this, animations may be executed locally on the client using lightweight data packets containing parameters sent by the server, which may eliminate the need for video streaming and ensure compatibility across diverse devices and operating systems. Servers may be geographically distributed to reduce latency and comply with local gaming regulations, enhancing the overall user experience. Synchronization between the server and client may be achieved through a ping-pong process, which may align the client's game clock with the server clock while measuring round-trip time to estimate latency and detect disconnections, ensuring seamless gameplay.

Game clocks on the client may be synchronized with the server to maintain real-time alignment of game events and user actions. The server may adjust timestamps of client requests based on measured latency, creating adjusted timestamps that account for network delays and ensuring fairness in gameplay. Predictable time windows for accepting user actions, such as during table creation or seat reconfiguration, may be defined by the server and synchronized with the client's game clock to ensure consistency. This synchronization may allow the system to handle user actions efficiently, even in scenarios with varying network conditions. By aligning timestamps and defining predictable time windows, the system may provide a robust framework for managing real-time interactions in online gaming environments.

Card distribution during gameplay may rely on a cryptographically secure pseudo random number generator to ensure fairness and unpredictability. A deck management component 324 may configure and update the card deck for each round, dynamically adjusting the composition of the deck in gaming modes where cards distributed in previous rounds may not be reinserted. The order in which cards are distributed to players may also be randomized using the secure pseudo random number generator, further enhancing the integrity of the game. These measures may ensure that all players have an equal chance of success, regardless of their position or timing within the game. By leveraging secure randomization techniques, the system may uphold the principles of fairness and transparency in card-based gameplay.

A request management system may handle user actions by timestamping each request using the client's synchronized game clock, ensuring that all actions are recorded accurately. The server may adjust these timestamps based on latency and validate them by comparing the adjusted timestamp with the actual reception time, rejecting requests that exceed a predefined tolerance. Valid requests may be queued and prioritized based on their adjusted timestamps, following a first-come, first-served and first-in, first-out principle to maintain fairness. Each request may include a unique token containing the user identifier, table identifier, wallet identifier, and the nature of the request, ensuring traceability and preventing tampering. Suspicious requests may be flagged and recorded for further analysis, allowing the system to identify and address potential security threats.

A wallet management system may pre-allocate funds before a player joins a game, ensuring that sufficient resources are available for gameplay. The system may check the balance in the player's wallet and put on hold/pre-allocates the total amount required for the game, calculated as the standard wager multiplied by the number of rounds. If a player joins a game after it starts, the system may calculate catch-up wagers for missed rounds and deduct them from the wallet. Players exiting a game before its conclusion may receive refunds for wagers already bet, minus a casino commission, with refunds processed after a delay to prevent abuse. At the end of the game, unused funds may be refunded to the player's wallet, and winning players may receive their share of the pot, minus the casino commission. Each wallet may be uniquely identified and associated with a single user, with all transactions recorded in an unalterable ledger to ensure transparency and accountability.

The system may use an unalterable ledger, such as a private blockchain, to record all game-related transactions, including user identifiers, table identifiers, wallet identifiers, adjusted timestamps, and the nature of transactions. This ledger may allow retrospective reconstruction of games, ensuring traceability and auditability for compliance with gaming regulations. Fraud prevention may be supported by analyzing suspicious activities recorded in the ledger, enabling the system to identify and mitigate potential threats. By maintaining a comprehensive and secure record of all transactions, the system may provide a reliable foundation for resolving disputes and ensuring the integrity of the gaming platform. The use of blockchain technology may further enhance the system's ability to prevent tampering and unauthorized modifications.

The server may host a core game engine that manages game logic, including card distribution, pot updates, and win conditions, while a table management component 340 may track the state of each table, including the number of players, round number, pot value, and seat configuration. Between rounds, the system may allow players to join, exit, or partner during a seat reconfiguration phase, providing flexibility and adaptability in gameplay. An advantage play indicator may be calculated by the server based on the pot value and deck composition, and if payout odds exceed the odds of winning, the indicator may be set to “on” and displayed to players. This feature may help players make informed decisions during gameplay. By integrating these components, the system may deliver a dynamic and engaging gaming experience.

Transactions within the system may be secured using unique tokens that include user identifiers, table identifiers, wallet identifiers, and adjusted timestamps, ensuring data integrity and preventing unauthorized access. Predictable wagers may be calculated at the start of the game, allowing players to manage their spending effectively. If a player disconnects, the game may continue as if the player were still connected, with the player's wallet updated based on the game outcome. Reconnection may allow players to resume participation without losing progress or funds, ensuring a seamless experience. By securing all game-related information, including requests and transactions, the system may maintain the integrity and reliability of the gaming platform.

The system may be designed for scalability and performance, offering low-latency gameplay and efficient data transmission. By sending lightweight animation parameters instead of video streams, the system may reduce bandwidth requirements and support a wide range of devices and network conditions. Real-time synchronization of game clocks and adjusted timestamps may enable alignment of player actions and game events, ensuring a smooth and responsive gaming experience. A game surveillance component may record suspicious or abnormal requests, analyzing them periodically to detect fraud patterns and improve system robustness. Requests with discrepancies in timestamps or invalid data may be flagged for further investigation, enhancing the security and reliability of the system.

Users may create accounts with identity verification based on know-your-customer principles, providing personal information and, in some cases, identification verification. Strong authentication protocols, such as multi-factor authentication, may be used to secure access to user accounts, ensuring that only authorized users can participate in gameplay. Geolocation verification may ensure compliance with local gaming regulations, using methods such as GPS, Wi-Fi, cell triangulation, or IP-based geolocation. If a player disconnects, the system may automatically continue the game with the player as if they were still connected, preserving the integrity of the game. Reconnection may allow players to resume participation without losing progress or funds, ensuring a fair and uninterrupted gaming experience.

Aspects of the subject matter described in this disclosure can be implemented to realize one or more of the following potential advantages. The described techniques may be implemented to support dynamic gameplay experiences by enabling players to interact with virtual tables in real-time while maintaining fairness through synchronized timestamps and secure transaction protocols. The system may facilitate seamless transitions between game phases, such as seat reconfiguration and card distribution, by leveraging lightweight data packets and cryptographically secure randomization methods. Players may benefit from transparent refund processes and predictable wagering structures, which may enhance trust and reduce financial risks during gameplay. The architecture may optimize resource allocation by distributing server workloads geographically, which may improve latency and compliance with regional regulations. By employing robust fraud detection mechanisms and maintaining an unalterable ledger, the system may uphold the integrity of gaming operations and provide a reliable framework for dispute resolution.

Aspects of the disclosure are initially described in the context of networked computing systems. Aspects of the disclosure are additionally illustrated by and described with reference to example implementations. Aspects of the disclosure are further illustrated by and described with reference to apparatus diagrams, system diagrams, and flowcharts that relate to synchronizing online gaming with secure transactions and real-time request management.

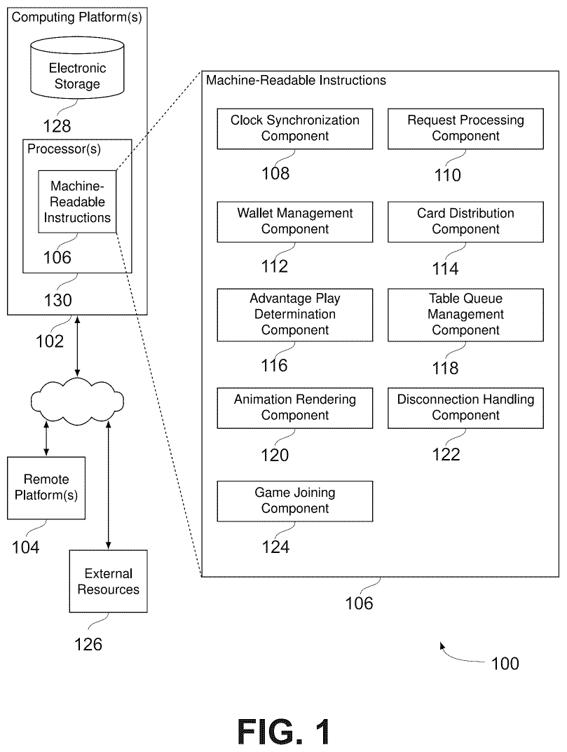

FIG. 1 illustrates an example of a system 100 for information processing configured for synchronizing online gaming with secure transactions and real-time request management in accordance with aspects of the present disclosure. In some implementations, system 100 may include one or more computing platforms 102. Computing platform(s) 102 may be configured to communicate with one or more remote platforms 104 according to a client/server architecture, a peer-to-peer architecture, and/or other architectures. Remote platform(s) 104 may be configured to communicate with other remote platforms via computing platform(s) 102 and/or according to a client/server architecture, a peer-to-peer architecture, and/or other architectures. Users may access system 100 via remote platform(s) 104.

Computing platform(s) 102 may be configured by machine-readable instructions 106. Machine-readable instructions 106 may include one or more instruction components. The instruction components may include computer program components. The instruction components may include one or more of a clock synchronization component 108, a request processing component 110, a wallet management component 112, a card distribution component 114, an advantage play determination component 116, a table queue management component 118, an animation rendering component 120, a disconnection handling component 122, a game joining component 124 and/or other instruction components.

The clock synchronization component 108 may be configured as or otherwise support a means for synchronizing a game clock of a client device with a server clock by performing a ping-pong process to compute round-trip time and may adjust timestamps for client requests. In some implementations, the clock synchronization component 108 may determine the latency between the client device and the server by measuring the time taken for a signal to travel to the server and return to the client device. The clock synchronization component 108 may periodically initiate the ping-pong process to maintain alignment between the client device's game clock and the server clock during gameplay. The clock synchronization component 108 may adjust the timestamps of client requests based on the determined latency to account for potential delays in communication.

The request processing component 110 may be configured as or otherwise support a means for processing client requests by validating adjusted timestamps, queuing the requests based on a first-come, first-served principle, and prioritizing the requests in real-time according to the adjusted timestamps. In some implementations, the request processing component 110 may validate adjusted timestamps by comparing them to a predefined tolerance range to detect potential discrepancies. The request processing component 110 may determine whether a request's adjusted timestamp aligns with the expected time window for the relevant game phase. The request processing component 110 may queue requests by assigning them to a specific table-level queue based on the unique table identifier associated with the request. In some implementations, the request processing component 110 may determine the order of requests in the queue by sorting them according to their adjusted timestamps. The request processing component 110 may prioritize requests in real-time by assigning higher priority to requests with earlier adjusted timestamps within the same queue. In some implementations, the request processing component 110 may determine priority conflicts by referencing the joining date of the user associated with the request.

The wallet management component 112 may be configured as or otherwise support a means for managing a wallet associated with a client by pre-allocating funds for a game session, updating the wallet based on game outcomes, and recording transactions in an unalterable ledger. In some implementations, the wallet management component 112 may determine the amount to be pre-allocated based on the total number of rounds and the standard wager associated with the selected table. In some implementations, the wallet management component 112 may pre-allocate funds by placing the required amount on hold within the wallet, ensuring it is reserved for the game session.

The wallet management component 112 may update the wallet based on game outcomes. In some implementations, the wallet management component 112 may determine the refund amount for a player exiting the game by subtracting a casino commission from the accumulated wagers. In some implementations, the wallet management component 112 may update the wallet by crediting the winnings of a player who achieves a winning combination during gameplay.

The wallet management component 112 may record transactions in an unalterable ledger. In some implementations, the wallet management component 112 may record the unique identifiers of the client, table, and wallet along with the timestamp of the transaction. In some implementations, the wallet management component 112 may record the pre-allocated funds, refunds, and winnings as separate entries in the ledger for traceability.

The card distribution component 114 may be configured as or otherwise support a means for distributing cards for gameplay by generating random numbers through a cryptographically secure random number generator and updating game states based on distributed cards. In some implementations, the card distribution component 114 may determine the sequence of card distribution by assigning random numbers to each card in the deck and sorting them accordingly. In some implementations, the card distribution component 114 may generate random numbers to allocate cards to players in a predefined order, such as clockwise or counterclockwise around a virtual table. The card distribution component 114 may determine the next card to be distributed by referencing a shuffled virtual deck stored in memory. In some implementations, the card distribution component 114 may update the game states by recording the cards distributed to each player and the remaining cards in the deck. In some implementations, the card distribution component 114 may update the game states by marking players as eliminated from a game round if they receive specific card types, such as build cards.

In some examples, the advantage play determination component 116 may be configured as or otherwise support a means for determining a threshold for triggering an advantage play indicator by comparing a ratio of accumulated wagers to a standard wager with a predefined value based on a composition of a card deck used in the wager accumulation game. In some implementations, the advantage play determination component 116 may determine the predefined value by referencing the number of half pot cards and build cards in the deck. In some implementations, the advantage play determination component 116 may determine the ratio of accumulated wagers to a standard wager by dividing the total accumulated wagers by the standard wager amount associated with the table. In some implementations, the advantage play determination component 116 may determine whether the ratio exceeds the predefined value by performing a comparison operation between the computed ratio and the predefined threshold.

In some examples, the table queue management component 118 may be configured as or otherwise support a means for managing a queue of client requests at a table level by assigning adjusted timestamps to the requests, sorting the requests in chronological order, and processing the requests sequentially during a predefined time window. In some implementations, the table queue management component 118 may assign adjusted timestamps by synchronizing client timestamps with a server clock and applying latency adjustments based on round-trip time measurements. In some implementations, the table queue management component 118 may determine the adjusted timestamps by referencing a predefined tolerance range to validate the accuracy of the client-provided timestamps. In some implementations, the table queue management component 118 may sort the requests in chronological order by comparing the adjusted timestamps of multiple requests and arranging them from the earliest to the latest. In some implementations, the table queue management component 118 may determine the order of requests by prioritizing those with earlier adjusted timestamps while maintaining the sequence of requests submitted within the same time frame. In some implementations, the table queue management component 118 may process the requests sequentially by iterating through the sorted queue and executing the actions associated with each request in the order they appear. In some implementations, the table queue management component 118 may determine whether a request falls within the predefined time window by comparing the adjusted timestamp of the request to the start and end times of the relevant game phase.

In some examples, the animation rendering component 120 may be configured as or otherwise support a means for distributing animation parameters to the client device for rendering game animations locally by transmitting data strings representing card distribution sequences and round outcomes. In some implementations, the animation rendering component 120 may transmit data strings that include parameters for animating the movement of chips across the virtual table during wager accumulation phases. In some implementations, the animation rendering component 120 may determine the timing of animations by referencing predefined durations associated with specific game phases, such as card distribution or seat reconfiguration.

In some implementations, the animation rendering component 120 may transmit data strings that specify the sequence of animations by referencing the order in which players are seated at the virtual table.

In some examples, the disconnection handling component 122 may be configured as or otherwise support a means for handling a client disconnection by continuing the wager accumulation game with pre-allocated funds, updating game states on the server, and crediting or debiting the wallet based on game results. In some implementations, the disconnection handling component 122 may determine the pre-allocated funds by referencing the total number of rounds and the standard wager associated with the table. In some implementations, the disconnection handling component 122 may maintain the wager accumulation game by treating the disconnected client as if they were still actively participating in the game.

In some implementations, the disconnection handling component 122 may update game states on the server by recording the outcomes of each round as if the disconnected client were still present. In some implementations, the disconnection handling component 122 may determine the status of the disconnected client by referencing the adjusted timestamps of their last recorded actions. In some implementations, the disconnection handling component 122 may ensure that the disconnected client's seat remains occupied for the duration of the game session.

In some implementations, the disconnection handling component 122 may credit the wallet of the disconnected client by determining the refund amount based on the number of remaining rounds and the standard wager. In some implementations, the disconnection handling component 122 may debit the wallet of the disconnected client by determining the casino commission applicable to the accumulated wagers. In some implementations, the disconnection handling component 122 may record the wallet transactions in an unalterable ledger for traceability.

In some examples, the game joining component 124 may be configured as or otherwise support a means for enabling a client to join an ongoing game by placing a catch-up wager that may be equal to missed wagers from prior rounds and updating the game state to include the client as an active participant. In some implementations, the game joining component 124 may validate the client's wallet balance to ensure it may cover the total number of rounds and the standard wager associated with the selected table which comprises the catch-up wager before processing the request.

In some implementations, the game joining component 124 may update the game state by adding the client's unique identifier to the list of active participants for the next round. In some implementations, the game joining component 124 may assign the client to an available seat at the virtual table based on the current table configuration. In some implementations, the game joining component 124 may adjust the pot value to include the catch-up wager placed by the client, ensuring the wager accumulation reflects the updated participant count.

In some implementations, computing platform(s) 102, remote platform(s) 104, and/or external resources 126 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 102, remote platform(s) 104, and/or external resources 126 may be operatively linked via some other communication media.

A given remote platform may include one or more processors configured to execute computer program components. The computer program components may be configured to enable an expert or user associated with the given remote platform to interface with system 100 and/or external resources 126, and/or provide other functionality attributed herein to remote platform(s) 104. By way of nonlimiting example, a given remote platform and/or a given computing platform may include one or more of a desktop computer, a laptop computer, a handheld computer, a tablet computing platform, a NetBook, a Smartphone, a gaming console, and/or other computing platforms. In some implementations, the computing platform(s) 102 may comprise server(s), and the remote platform(s) 104 may comprise remotely located client computing platform(s).

External resources 126 may include sources of information outside of system 100, external entities participating with system 100, and/or other resources. In some implementations, some or all of the functionality attributed herein to external resources 126 may be provided by resources included in system 100.

Computing platform(s) 102 may include electronic storage 128, one or more processors 130, and/or other components. Computing platform(s) 102 may include communication lines, or ports to enable the exchange of information with a network and/or other computing platforms. Illustration of computing platform(s) 102 in FIG. 1 is not intended to be limiting. Computing platform(s) 102 may include a plurality of hardware, software, and/or firmware components operating together to provide the functionality attributed herein to computing platform(s) 102. For example, computing platform(s) 102 may be implemented by a cloud of computing platforms operating together as computing platform(s) 102.

Electronic storage 128 may comprise non-transitory storage media that electronically stores information. The electronic storage media of electronic storage 128 may include one or both of system storage that is provided integrally (i.e., substantially nonremovable) with computing platform(s) 102 and/or removable storage that is removably connectable to computing platform(s) 102 via, for example, a port (e.g., a USB port, a firewire port, etc.) or a drive (e.g., a disk drive, etc.). Electronic storage 128 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 128 may include one or more virtual storage resources (e.g., cloud storage, a virtual private network, and/or other virtual storage resources). Electronic storage 128 may store software algorithms, information determined by processor(s) 130, information received from computing platform(s) 102, information received from remote platform(s) 104, and/or other information that enables computing platform(s) 102 to function as described herein.

Processor(s) 130 may be configured to provide information processing capabilities in computing platform(s) 102. As such, processor(s) 130 may include one or more of a digital processor, an analog processor, a digital circuit designed to process information, an analog circuit designed to process information, a state machine, and/or other mechanisms for electronically processing information. Although processor(s) 130 is shown in FIG. 1 as a single entity, this is for illustrative purposes only. In some implementations, processor(s) 130 may include a plurality of processing units. These processing units may be physically located within the same device, or processor(s) 130 may represent processing functionality of a plurality of devices operating in coordination. Processor(s) 130 may be configured to execute components 108, 110, 112, 114, 116, 118, 120, 122, 124, and/or other components. Processor(s) 130 may be configured to execute components 108, 110, 112, 114, 116, 118, 120, 122, 124, and/or other components by software; hardware; firmware; some combination of software, hardware, and/or firmware; and/or other mechanisms for configuring processing capabilities on processor(s) 130. As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although components 108, 110, 112, 114, 116, 118, 120, 122, and/or 124 are illustrated in FIG. 1 as being implemented within a single processing unit, in implementations in which processor(s) 130 includes multiple processing units, one or more of components 108, 110, 112, 114, 116, 118, 120, 122, and/or 124 may be implemented remotely from the other components. The description of the functionality provided by the different components 108, 110, 112, 114, 116, 118, 120, 122, and/or 124 described below is for illustrative purposes, and is not intended to be limiting, as any of components 108, 110, 112, 114, 116, 118, 120, 122, and/or 124 may provide more or less functionality than is described. For example, one or more of components 108, 110, 112, 114, 116, 118, 120, 122, and/or 124 may be eliminated, and some or all of its functionality may be provided by other ones of components 108, 110, 112, 114, 116, 118, 120, 122, and/or 124. As another example, processor(s) 130 may be configured to execute one or more additional components that may perform some or all of the functionality attributed below to one of components 108, 110, 112, 114, 116, 118, 120, 122, and/or 124.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure and accordingly do not represent all of the technical improvements provided within the scope of the claims.

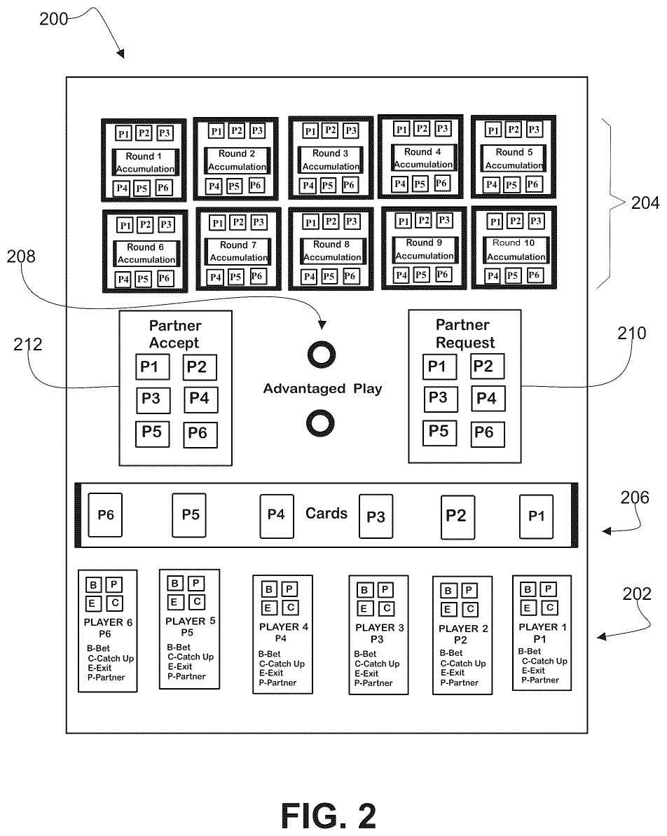

FIG. 2 shows a physical casino gaming board 200 which inspires techniques for synchronizing online gaming with secure transactions and real-time request management in accordance with various aspects of the present disclosure. As depicted in FIG. 2, the physical casino gaming board 200 may include one or more of a wagering station 202, a wager accumulation station 204, an advantaged play indicator 206, a card distribution area 208, a partner request station 210 and a partner accept station 212, and/or other components.

The wagering station 202 may include a designated area for players to place their standard wagers, as physical chips or tokens, during gameplay. The wagering station 202 may be configured to visually display the wagers placed by players, allowing for clear tracking during the game. The wagering station 202 may include individual sections corresponding to each player's position at the table, ensuring that wagers are organized by player. In some implementations, the wagering station 202 may be positioned on a seating players side.

The wager accumulation station 204 may represent a segmented area for tracking and storing wagers transferred from the wagering stations across multiple rounds. The wager accumulation station 204 may include distinct sections labeled by round number and player position, allowing for precise tracking of contributions throughout the game by a physical dealer. Chips or tokens are moved by the physical dealer from the wagering station to the wager accumulation station before the start of a game round. The wager accumulation station 204 may visually display the total accumulated wagers for each round, enabling players and the dealer to monitor the progression of the game. The game board comprises an advantaged play indicator 206, preferably located in a central area of the game board, to signal when payout odds exceed the odds of winning.

The advantaged play indicator 206 may provide a visual cue to signal when payout odds exceed the odds of winning based on game conditions. The advantaged play indicator 206 may be activated by the dealer when the accumulated wagers in the wager accumulation station 204 surpass a predetermined threshold. The advantaged play indicator 206 may include a light or digital display that is visible to all players at the table, ensuring transparency during gameplay.

The card distribution area 208 may include a designated space for the dealer to distribute cards to players in an established order. The card distribution area 208 may be organized to provide a clear view of the distribution process for all players.

The partner request station 210 may represent an interface for a player or a non-player wishing to join the game to indicate their willingness to partner with others. The partner request station 210 may be connected to the partner accept station 212 to facilitate the pairing of players. The partner request station 210 may include an area segmented by players, where partnership requests may be indicated by placing chips or tokens on a segment to request a partnership with the player associated with this segment.

The partner accept station 212 is an area of the game board where seating players may accept incoming partnership requests. The partner accept station 212 may include an area, segmented by players, where partnership requests may be accepted by a player placing chips or tokens on his segment to accept a partnership request placed in the same segment of the partner request station 210.

In some implementations, the wagering station 202 may be positioned at the edge of the table layout, allowing players to place their standard wagers before the start of a round. The wager accumulation station 204 may be arranged in a grid format on the opposite side of the game board, in front of the dealer, segmented by round number and player position, to visually track the transfer of wagers from the wagering station 202. The advantaged play indicator 206 is triggered by the dealer and may light up or change state when the payout odds exceed the odds of winning.

In some implementations, the card distribution area 208 may be centrally located on the table board and may comprise a plurality of locations configured for receiving cards for each player.

The online game is inspired from this physical casino game and may reproduce part or all of these features in a format suitable for digital display and online gaming.

In online gaming the players are users connected through a network to a server with devices comprising a client app, The server comprises components to create tables, and components to run a game comprising multiple rounds at each table. The game is conducted by a game engine drawing cards from an electronic card deck assigning each drawn card to a player participating to the game at a table connected to the server through his client app.

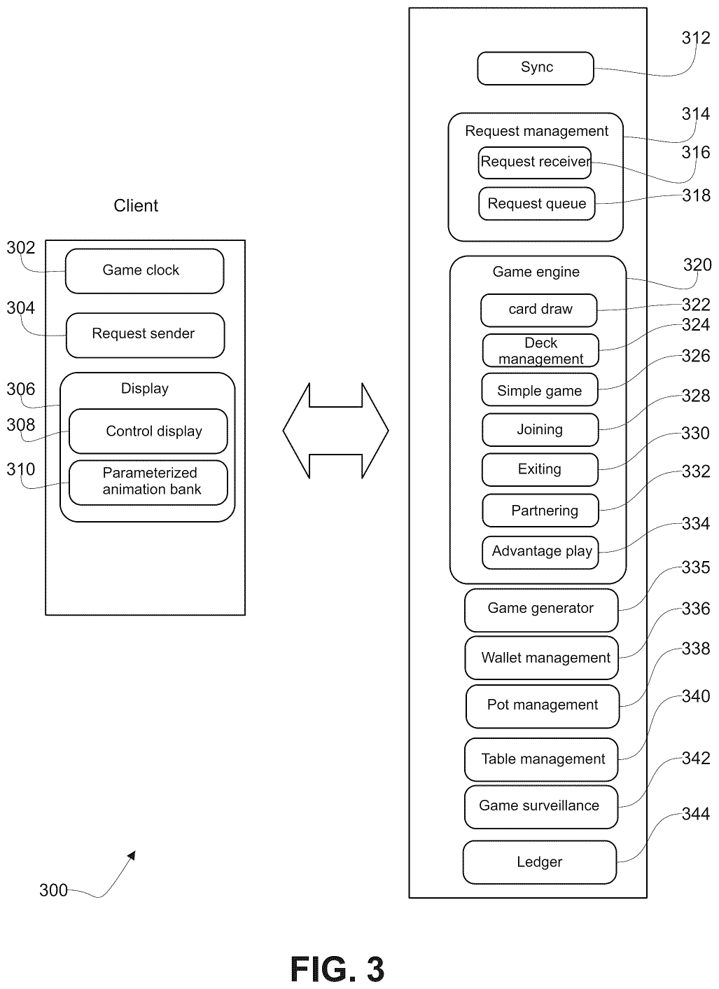

FIG. 3 shows client-server architecture 300 which supports techniques for synchronizing online gaming with secure transactions and real-time request management in accordance with various aspects of the present disclosure. As depicted in FIG. 3, the client-server architecture 300 may include one or more of a game clock 302, a request sender 304, a display 306, a control display 308, a parameterized animation bank 310, synchronization component 312, request management component 314, a request receiver 316, a request queue component 318, a game engine 320, card draw component 322, deck management component 324, a simple game component 326, joining request processing component 328, exiting request processing component 330, partnering request processing component 332, advantage play processing component 334, game generator 335, wallet management component 336, pot management component 338, table management component 340, game surveillance 342, a ledger 344, and/or other components.

The game clock 302 may synchronize the client-side gaming experience with the server-side game progression. The game clock 302 may periodically align with the server clock through a synchronization process, which may involve a Ping/Pong mechanism to determine latency. The game clock 302 may timestamp user requests, such as joining or exiting a table, to ensure accurate sequencing of events. The synchronization component 312 may work in conjunction with the game clock 302 to adjust timestamps for latency, ensuring fairness in request processing.

The request sender 304 may transmit user-generated requests to the server for processing. The request sender 304 may package user actions, such as joining, exiting, or partnering, into data packets that may include timestamp, user and table identifiers.

The request receiver 316 may validate incoming requests from the request sender 304 before they are queued for processing.

The display 306 may render visual elements of the game interface based on server-provided parameters. The display 306 may include areas for showing table information, such as the pot amount, round number, and advantage play indicator. The display 306 may render animations, such as card distribution sequences, using parameters received from the server. The parameterized animation bank 310 may store animations that the display 306 may retrieve and render based on server-provided parameters. In some implementations, the display 306 may adapt its layout to different device types, such as smartphones, tablets, or desktops.

The control display 308 may include interactive elements for user actions such as joining, exiting, or partnering. The control display 308 may feature buttons for sending requests to the server, such as a “Join Table” or “Exit Game” button. The control display 308 may visually indicate the status of actions, such as whether a partnering request has been accepted. The request sender 304 may transmit user actions initiated through the control display 308 to the server for processing. In some implementations, the control display 308 may include a wallet balance indicator to inform users of their available funds.

The parameterized animation bank 310 may store animations that are triggered by server-provided parameters. The parameterized animation bank 310 may include pre-designed sequences for events like card distribution, round progression, and timer countdowns. The parameterized animation bank 310 may allow animations to be customized based on the number of players or the type of game being played. The display 306 may retrieve animations from the parameterized animation bank 310 and render them on the user interface. In some implementations, the parameterized animation bank 310 may support multiple animation styles to accommodate different game themes.

The synchronization component 312 may determine latency and align client and server clocks for real-time gameplay. The synchronization component 312 may use a Ping/Pong mechanism to measure round-trip time and adjust client timestamps accordingly. The synchronization component 312 may ensure that user actions are processed within the correct time windows, such as during seat reconfiguration periods. The game clock 302 may rely on the synchronization component 312 to maintain accurate timing for animations and user actions. In some implementations, the synchronization component 312 may detect and handle client disconnections to maintain game continuity.

The request management component 314 may organize and prioritize incoming user requests based on adjusted timestamps. The request management component 314 may queue requests, such as joining or exiting a table, in a sequence determined by their timestamps. The request management component 314 may reject requests with timestamps falling outside predefined time windows. The request queue component 318 may work with the request management component 314 to arrange validated requests for processing. In some implementations, the request management component 314 may log rejected requests for analysis by the game surveillance 342.

The request receiver 316 may accept and validate incoming requests from clients. The request receiver 316 may check the integrity of requests, such as verifying user and table identifiers couples and timestamps. The request receiver 316 may forward validated requests to the request queue component 318 for sequencing. The request sender 304 may transmit requests to the request receiver 316, which may validate them before processing. In some implementations, the request receiver 316 may flag suspicious requests for further analysis by the game surveillance 342.

The request queue component 318 may arrange validated requests in a sequence for processing. The request queue component 318 may prioritize requests based on their adjusted timestamps to ensure fairness. The request queue component 318 may handle multiple types of requests, such as joining, exiting or partnering, within the dedicated queues. The request management component 314 may rely on the request queue component 318 to organize requests for execution by the game engine 320. In some implementations, the request queue component 318 may dynamically adjust its processing order based on server load.

The game engine 320 may execute the core logic of the game, including round progression and win determination. The game engine 320 may manage the distribution of cards to players and determine the outcome of each round. The game engine 320 may update the pot amount based on wagers placed during each round. The card draw component 322 may work with the game engine 320 to determine random card distributions for players. In some implementations, the game engine 320 may support different game modes, such as simplified or full modes.

The card draw component 322 may determine random card distributions for players during gameplay. The card draw component 322 may use a cryptographically secure pseudo random number generator to ensure fairness in card selection. The card draw component 322 may handle scenarios where players receive special cards, such as half pot cards or build cards. The deck management component 324 may provide the card draw component 322 with the current composition of the deck. In some implementations, the card draw component 322 may adjust its logic based on the number of players and rounds.

The deck management component 324 may track the composition and state of the card deck throughout the game. The deck management component 324 may update the deck after each round, such as by reinserting distributed cards or removing them in advanced game modes. The deck management component 324 may ensure that the correct number of build cards and half pot cards are available for each round. The card draw component 322 may rely on the deck management component 324 to access the current state of the deck. In some implementations, the deck management component 324 may support custom deck configurations for different game variants.

The simple game component 326 may support a streamlined version of the game with predefined rules and parameters. The simple game component 326 may limit the number of players to six and the number of rounds to ten. The simple game component 326 may exclude features like partnering and exiting to simplify gameplay. The game engine 320 may work with the simple game component 326 to execute the core logic of the simplified game mode. In some implementations, the simple game component 326 may allow users to play against virtual players, such as casino bots.

The joining request processing component 328 may handle user requests to join a table during the game.

The exiting request processing component 330 may manage user requests to leave a table and process refunds.

The partnering request processing component 332 may process requests for users to form partnerships with seated players.

The advantage play processing component 334 may determine whether payout odds exceed winning odds based on game parameters.

The game generator 335 may create games of the simplified version or of the full game version. A simplified game may be created upon request of a user. The game generator 335 may automatically generate full games from time to time. The game generator 335 may also generate customized full games upon request of a user.

The wallet management component 336 may track and update the user's wallet balance during gameplay. The wallet management component 336 may ensure that sufficient funds are available for actions like creating a table, joining or partnering. The wallet management component 336 may handle refunds for players who exit the game before its conclusion. The pot management component 338 may work with the wallet management component 336 to update the pot amount based on wagers. In some implementations, the wallet management component 336 may support automatic replenishment options for users.

The pot management component 338 may monitor the accumulation of wagers in the pot across rounds. The pot management component 338 may update the pot amount after each round based on the number of players and their wagers. The pot management component 338 may calculate the payout amount for winners, deducting the casino commission. The wallet management component 336 may interact with the pot management component 338 to process refunds for exiting players. In some implementations, the pot management component 338 may display the pot amount on the user interface.

The table management component 340 may cooperate with the game generator 335, the game engine 320, and the pot management component 338 and may maintain records of table configurations, players seating, and game states. The table management component 340 may track the number of players at each table and their seating positions. The table management component 340 may update the table configuration after actions like joining, exiting, or partnering. The request management component 314 may rely on the table management component 340 to validate user actions based on table states. In some implementations, the table management component 340 may support custom table configurations, such as varying the number of rounds or players.

The game surveillance 342 may record and analyze suspicious or abnormal user activity during gameplay. The game surveillance 342 may flag requests with inconsistent timestamps or user identifiers for further investigation. The game surveillance 342 may log patterns of behavior that may indicate potential fraud or system tampering. The request management component 314 may forward flagged requests to the game surveillance 342 for analysis. In some implementations, the game surveillance 342 may generate reports to help administrators identify and address security issues.

The ledger 344 may store immutable records of transactions and game events for traceability. The ledger 344 may record user actions, such as joining, exiting or partnering, along with their timestamps and identifiers. The ledger 344 may maintain a history of pot updates and payouts for auditing purposes. The table management component 340 may reference the ledger 344 to reconstruct game events for analysis. In some implementations, the ledger 344 may use blockchain technology to ensure data integrity and security.

In some implementations, the client-side components, including the game clock 302, request sender 304, and display 306, may interact with the server-side synchronization component 312 to maintain consistent timing across the system. The game clock 302 may synchronize with the server's timing through a Ping/Pong process, while the request sender 304 may transmit player actions to the request receiver 316 on the server. The display 306, which may include the control display 308 and parameterized animation bank 310, may render animations based on parameters received from the server, ensuring that the visual representation aligns with the server-processed game state.

In some implementations, the server-side request management component 314, which may include the request receiver 316 and request queue component 318, may handle incoming player actions by timestamping and queuing them for processing. These requests may then be routed to the table management component 340, after being processed by one of the joining request processing component 328, exiting request processing component 330, partnering request processing component 332. The game engine 320 may use the information thus updated in the table management component 340 to define the configuration of a game round. The game engine 320 may interact with the wallet management component 336 to verify player funds, the pot management component 338 to update wager accumulations, and the table management component 340 to track player positions and game progression.

In some implementations, the game surveillance component 342 may monitor requests and gameplay for irregularities, while the ledger 344 may record transactions and game events for auditability. The joining request processing component 328, exiting request processing component 330, and partnering request processing component 332 may operate within the game engine 320 to manage dynamic player interactions during the game. The advantage play processing component 334 may determine payout odds based on the deck composition and pot value, relaying this information to the client for display.

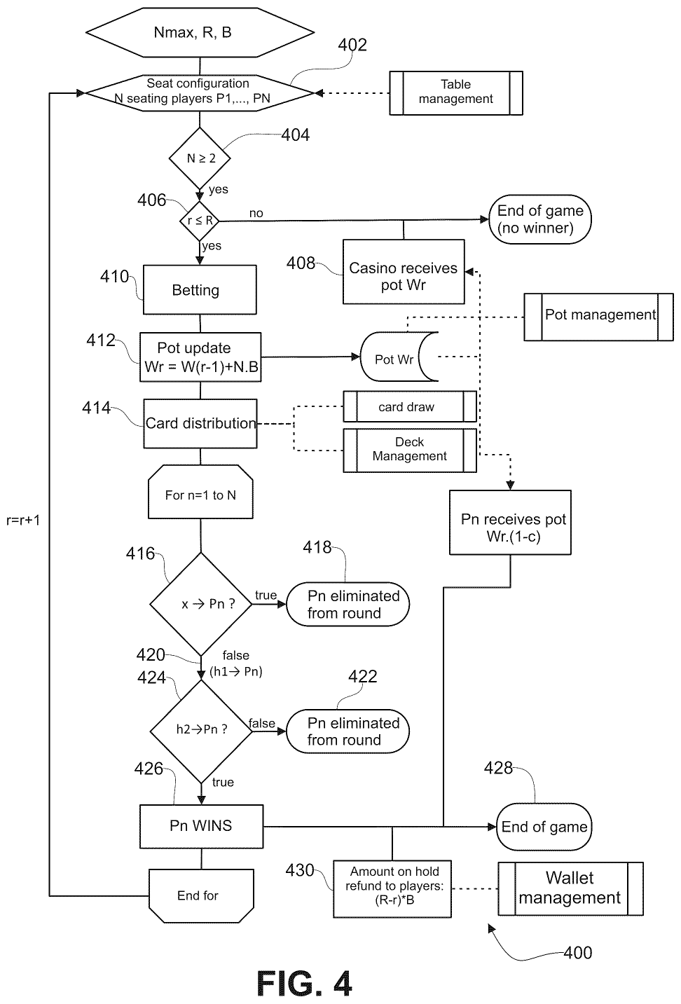

FIG. 4 illustrates a game engine flowchart 400 that supports techniques for synchronizing online gaming with secure transactions and real-time request management in accordance with various aspects of the present disclosure. Operations illustrated in the game engine flowchart 400 may involve a game engine, a table management component 340, a pot management component, a card draw component 322, and a deck management component 324, which may be examples of corresponding devices described herein. The game engine flowchart 400 may describe a process for managing player participation, betting, pot updates, card distribution, and determining winners or eliminations in a multi-round game.

At 402, the game engine may set the configuration of n seating players p. 1, . . . , pn. In some implementations, the game engine may retrieve the number of players n from the table management component 340. In some implementations, the table management component 340 may identify the unique identifiers of the players p. 1, . . . , pn who are currently seated at the table. In some implementations, the game engine may determine the seating arrangement of the players p. 1, . . . , pn based on the order in which they joined the table. In some implementations, the game engine may update the table configuration to reflect any changes in the number of players due to joining, exiting or partnering.

A maximum Nmax of seating players may join a table, the game may be run over a maximum of R rounds, and a standard wager of B. At each round of the game the pot may increase by N*B, N being the number of seating players actually at the table for the round with 2≤N≤Nmax.

The game may be run with a deck of cards comprising build cards x and half pot cards h, the deck composition may be stored and updated in the deck management component 324. At the beginning of the game the deck may comprise a total of Nc cards distributed between the two categories x, and h. Depending on the game mode the composition of the deck of cards may be the same for each round comprising X0 build cards and H0 half pot cards with X0<H0, which, compared to the physical casino game described herein, is equivalent to reinsert the distributed cards after each round and shuffling the deck. In some other implementations, the card deck may initially comprise X0 build cards and HO half pot cards with X0<H0 for a total of Nc cards (H0+N0), but the cards distributed during a round may not be reinserted in the deck, the deck thus comprising X build cards and H half pot cards where X and H may be different from X0 and H0. According to the physical casino game principle described herein, when a player receives a build card x the player is eliminated from the round. When a player receives a half pot card h1 the same player is subsequently given a second card. If this second card is a build card x the player is eliminated from the round. If this second card is a half pot card h2 the player wins the game.

At 404, the game engine may determine whether n is greater than or equal to 2. In some implementations, the game engine may check the value of n against a predefined threshold stored in the table management component 340. In some implementations, the game engine may retrieve the current number of players n from the table management component 340 to perform this determination. In some implementations, the game engine may proceed to the next step if the condition n≥2 is satisfied. In some implementations, the game engine may terminate the game if the condition n≥2 is not satisfied.

At 406, the game engine may determine whether the current round number r is less than or equal to the total number of rounds R. In some implementations, the game engine 320 may retrieve the current round number r from the table management component 340. In some implementations, the total number of rounds R may be a predefined value associated with the table configuration. In some implementations, the game engine may compare the current round number r to the total number of rounds R to decide whether to continue the game. In some implementations, the game engine may end the game if the current round number r exceeds the total number of rounds R.

At 408, the pot management component 338 may transfer the amount in the pot Wr to the casino. In some implementations, the pot management component may retrieve the current pot amount Wr from the table management component 340. In some implementations the pot management component 338 may interact with the wallet management component 336 to update the player's wallets. In some implementations, the pot management component 338 may record the transfer of the pot Wr to the casino in a ledger for audit purposes. In some implementations, the pot management component 338 may notify the table management component 340 that the transfer of the pot Wr to the casino has been completed.

At 410, the game engine may initiate a betting phase for the seating players. In some implementations. In some implementations, the game engine may retrieve the standard wager amount B from the table management component 340. In some implementations, the game engine 320 may record the wagers placed by the players in the table management component 340.

At 412, the pot management component may update the pot Wr by adding the wagers from the current round to the previous pot amount W(r−1). In some implementations, the pot management component 338 may retrieve the previous pot amount W(r−1) from the table management component 340. In some implementations, the pot management component 338 may calculate the total wagers placed by the players in the current round. In some implementations, the pot management component 338 may add the total wagers from the current round to the previous pot amount W(r−1) to determine the updated pot amount Wr. In some implementations, the pot management component 338 may store the updated pot amount Wr in the table management component 340.

At 414, the card draw component 322 and the deck management component 324 may distribute cards to the seating players. In implementations, the card draw component 322 may use a cryptographically secure pseudo random number generator to determine the order of card distribution. In some implementations, the deck management component 324 may retrieve the current composition of the deck to ensure that the cards are distributed randomly. In some implementations, the card draw component 322 may assign a card to each player p. 1, . . . , pn based on the distribution order. In some implementations, the deck management component 324 may update the deck composition to reflect the cards that have been distributed.

At 416, the game engine may determine whether a build card x is distributed to a player pn. In some implementations, the game engine may retrieve the card assigned to player pn from the card draw component 322. In some implementations, the game engine may compare the card assigned to player pn to predefined types of cards in the deck.

At 418, the game engine may eliminate player pn from the round if a build card x is distributed to pn. In some implementations, the game engine may proceed to the next player in the distribution order.

At 420, the game engine may determine whether a half pot card h1 is distributed to a player pn. In some implementations, the game engine may distribute a second card to player pn having received a half pot card h1.

At 422, the game engine may eliminate player pn from the round if a if the second card distributed to payer pn is not a half pot card. In some implementations, the game engine may notify the eliminated player pn that he has been removed from the round.

At 424, the game engine may determine whether a second half pot card h2 is distributed to player pn. In some implementations, the game engine may proceed to the next step if the second card assigned to player pn is identified as a half pot card h2. In some implementations, the game engine may continue the round if the second card assigned to player pn is not a half pot card h2.

At 426, the game engine may declare player pn as the winner if a second half pot card h2 is distributed to pn. In some implementations, the game engine may notify the table management component 340 that player pn has won the game. In some implementations, the game engine may instruct the pot management component to transfer the pot Wr to the winning player pn. In some implementations, the game engine may record the outcome of the game in a ledger for audit purposes. In some implementations, the game engine may notify the other players that the game has ended with player pn as the winner.

At 428, the game engine may end the game after determining a winner. In some implementations, the game engine may update the table management component 340 to indicate that the game has concluded. In some implementations, the game engine may notify the players that the game has ended. In some implementations, the game engine may record the final state of the game in a ledger for audit purposes.

At 430, the game engine may instruct the wallet manager to refund the amount on hold to players based on the number of remaining rounds (R−r) multiplied by the standard wager B, if a winner wins the game at round r before the last round. In some implementations, the game engine may retrieve the number of remaining rounds (R−r) from the table management component 340. The players may be notified of the refund by the wallet management component.

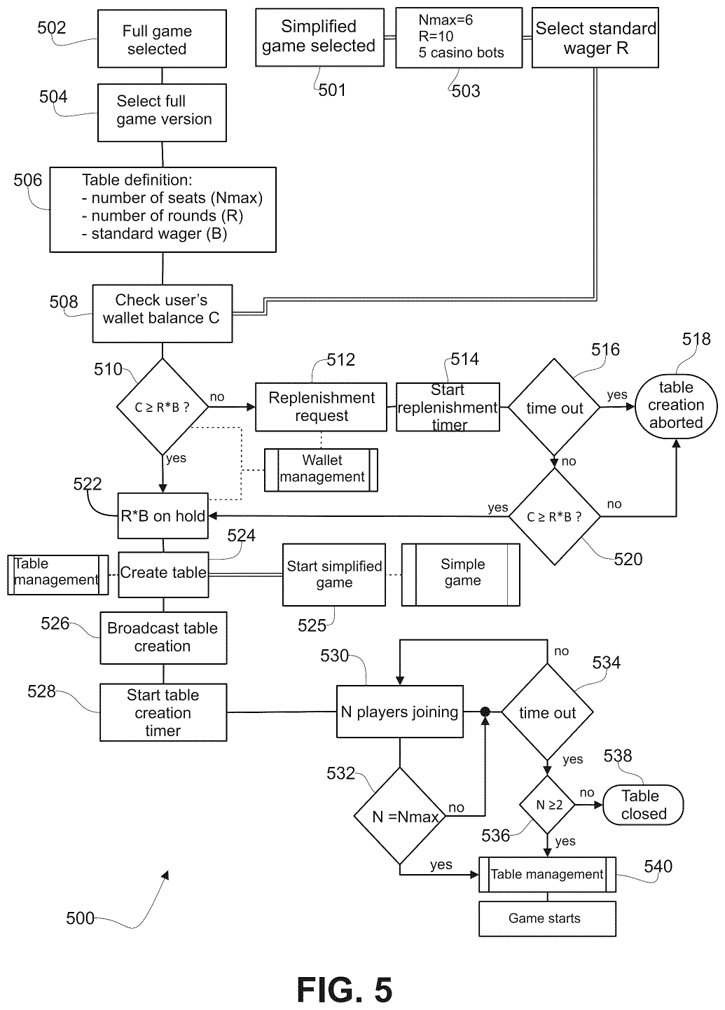

FIG. 5 illustrates a game generation flowchart 500 by the game generator 335 component that supports techniques for synchronizing online gaming with secure transactions and real-time request management in accordance with various aspects of the present disclosure. Operations illustrated in the game generation flowchart 500 may involve a wallet management component, a table management component 340, a game engine, which may be examples of corresponding devices described herein. The game generation flowchart 500 may describe a process for defining game parameters, verifying wallet balances, managing table creation, and initiating gameplay based on user and system inputs.

A game may be generated by the game generator 335 upon user request for generating a simplified game, by the game generator 335 itself from time to time, generating games in full modes. The game generator 335 may also generate a game in standard full mode or in advanced full modes upon a user request, allowing the user to customize the game. Whether a game in full mode is generated by the game generator 335 itself or upon request of a user for customization the game may be generated according to the game generation flowchart 500, except that the steps pertaining to the wallet balance check may not be considered in the automatic generation of a game by the game generator 335. The wallet balance check may then be performed upon request of a player for joining the automatically generated game, as described herein.

Full modes may comprise standard full mode and advanced full mode. In the standard full mode the game may comprise up to Nmax=25 seats and may be run over a maximum of R=10 rounds with a card deck comprising X0=40 build cards and H0=10 half pots cards, the card deck composition being the same for each round. In the advanced full mode the initial card deck composition (X0, H0) is configured depending on the number of seats (Nmax) and the maximum number of rounds (R). The card deck composition changes at each round as the cards distributed during the previous round are not reinserted in the deck. According to some nonlimiting examples, a game in advanced full mode may have the following features:

$$Nmax = 4 , R = 8 , X 0 = 32 , H 0 = 12 ;$$

$$Nmax = 6 , R = 10 , X 0 = 60 , H 0 = 14 ;$$

$$Nmax = 8 , R = 12 , X 0 = 96 , H 0 = 17 .$$

A user interface may comprise button for selecting a game mode.

A user may have sent a request for participating in a simplified game mode, upon receipt of such request, at 501 the game generator 335 may select the simplified game generation.

At 503, the simplified game generation being selected, the game generator 335 may configure the game, the simplified game may have a fix configuration comprising for instance 6 seats (Nmax=6) and a maximum of 10 rounds (R=10) all seats except one, the user's seat, being occupied by casino bots. In some implementation the game generator 335 may allow the user requesting a simplified game to select among preset configurations comprising more or less than 6 seats and more or less than 10 rounds.

Casino bots are virtual players that may mainly be used for display in the user interface, since in the simplified game version the game engine may systematically increase the pot by Nmax*B after each round without a win.

At 505 the user may select the amount of the standard wager (B). Once the standard wager amount is selected the game generator 335 may jump to 508 to check user's wallet balance C in cooperation with the wallet management component.

At 510 the user's wallet balance C may be compared with the amount R*B required to cover the wagers of a player during the game maximum number of rounds R. If balance C is lower than the maximum of rounds R multiplied by the standard wager B (C<R*B) the user may be offered to replenish his wallet as described herein.

At 522 the amount R*B may be put on hold from the user's wallet by the wallet management component.

At 524 the simplified game table may be created and recorded into the table management component 340.

At 525 the simplified game may start, run by the simple game component of the game engine. The simple game may use a card deck comprising X0=40 build cards and H0=10 half pot card for each round.

A user may send a request for creating a table. Upon receipt of such a request, at 502, the game generator 335 may select the full game mode generation.

At 504, the game generator 335 may allow a user to select a full game version. The game generator 335 may present options for full game versions, such as standard full game and advanced full game, through the user interface. The game generator 335 may determine whether the selected version complies with local gaming regulations based on geolocation data.

At 506, the game generator 335 may define table parameters, which may include the number of seats, the number of rounds, and the standard wager, in case of an automatic game generation. The game generator 335 may allow the user to specify the number of seats (Nmax), the maximum number of rounds (R), and standard wager amount (B) through a table creation form. The game generator 335 may retrieve permissible combinations of seats and rounds from the table management component 340. The game generator 335 may determine whether the selected parameters align with the user's wallet balance as verified by the wallet management component. The game generator 335 may transmit the defined parameters to the table management component 340 for table creation.

At 508, the game generator 335 in cooperation with the wallet management component 336 may check the user's wallet balance. The wallet management component 336 may retrieve the user's wallet balance from a ledger associated with the user's unique identifier. The wallet management component 336 may determine whether the wallet balance is sufficient to cover the product of the maximum number of rounds (R) multiplied by the standard wager (B). The wallet management component 336 may log the wallet balance check in the game surveillance component for traceability.

At 510, the wallet management component 336 may determine whether the user's wallet balance is greater than or equal to the product of the maximum number of rounds and the standard wager. The wallet management component 336 may compute the required amount by multiplying the maximum number of rounds by the standard wager. The wallet management component 336 may compare the computed amount with the user's wallet balance C retrieved from the ledger. The wallet management component 336 may transmit the comparison result to the game generator 335 component for further processing. The wallet management component 336 may record the comparison result in the game surveillance component for audit purposes.

At 512, if the wallet balance C is insufficient the user may be offered to replenish his wallet. The wallet management component 336 may initiate a replenishment request if the user's wallet balance is insufficient. The wallet management component 336 may generate a replenishment request and display it on the user's device. The wallet management component 336 may retrieve payment options, such as credit card or bank transfer, from the user's profile. The wallet management component 336 may determine whether the replenishment request complies with local gaming regulations based on geolocation data. The wallet management component 336 may transmit the replenishment request to the user's device for action.

At 514, the wallet management component 336 may start a replenishment timer to allow the user to add funds to his wallet. The wallet management component 336 may determine the duration of the replenishment timer based on system settings. The wallet management component 336 may display the timer countdown on the user's device to indicate the remaining time for replenishment. The wallet management component 336 may log the start and end times of the replenishment timer in the game surveillance component.

At 516, the wallet management component 336 may determine whether the replenishment timer has timed out. The wallet management component 336 may compare the current time with the end time of the replenishment timer. The wallet management component 336 may retrieve a replenishment status to determine whether funds were added. The wallet management component 336 may transmit the times-out status to the table management component 340 for further action. The wallet management component 336 may record the times-out status in the game surveillance component for traceability.

At 518, the table management component 340 may abort the table creation process if the replenishment timer times out. The table management component 340 may retrieve the times-out status from the wallet management component. The table management component 340 may update the table status to “aborted” in the table management component 340. The table management component 340 may transmit the table abortion status to the user's device for display. The table management component 340 may log the table abortion event in the game surveillance component for audit purposes.

At 520, the wallet management component 336 may determine whether the user's wallet balance is sufficient after replenishment. The wallet management component 336 may retrieve the updated wallet balance from the ledger associated with the user's unique identifier. The wallet management component 336 may compare the updated balance with the required amount computed earlier. The wallet management component 336 may transmit the comparison result to the game generator 335 for further processing. The wallet management component 336 may record the comparison result in the game surveillance component for traceability.

At 522, the wallet management component 336 may place the required amount on hold from the user's wallet. The wallet management component 336 may deduct the required amount from the user's wallet and mark it as “on hold” in the ledger. The wallet management component 336 may associate the on-hold amount with the unique table identifier retrieved from the table management component 340. The wallet management component 336 may transmit the on-hold status to the table management component 340 for synchronization. The wallet management component 336 may log the on-hold transaction in the game surveillance component for audit purposes.

At 524, the table management component 340 may create the table based on the defined parameters. The table management component 340 may retrieve the defined parameters from the game generator 335. The table management component 340 may assign a unique identifier to the newly created table and store it in the table management component 340. The table management component 340 may transmit the table creation status to the user's device for display. The table management component 340 may log the table creation event in the game surveillance component for traceability.

At 526, the table management component 340 may broadcast the table creation to other users. The table management component 340 may transmit the table details, including the number of seats and maximum number of rounds, to the lobby interface of other users. The table management component 340 may determine the broadcast recipients based on user preferences stored in their profile. The table management component 340 may log the broadcast event in the game surveillance component for audit purposes.

At 528, the table management component 340 may start a table creation timer to allow users to join the table. The table management component 340 may determine the duration of the table creation timer based on system settings retrieved from the table management component 340. The table management component 340 may display the timer countdown on the lobby interface of other users. The table management component 340 may log the start and end times of the table creation timer in the game surveillance component.

Players may send joining requests to the newly created table, and such requests may be accepted until all seats are occupied and the table creation timer has not timed out.

At 530, the table management component 340 may track the number of players joining the table. The table management component 340 may retrieve joining requests from the request management component associated with the table management component 340. The table management component 340 may update the number of players at the table based on the processed joining requests. The table management component 340 may transmit the updated player count to the lobby interface of other users. The table management component 340 may log the player count updates in the game surveillance component for traceability.

At 532, the table management component 340 may determine whether the number of players joining the table equals the number of seats. The table management component 340 may compare the current player count with the total number of seats defined in the table parameters. The table management component 340 may record the comparison result in the game surveillance component for audit purposes.

At 534, the table management component 340 may determine whether the table creation timer has timed out. The table management component 340 may compare the current time with the end time of the table creation timer.

At 536, the table management component 340 may determine whether the number of players at the table is greater than or equal to two. The table management component 340 may compare the player having requested the game generation count with the minimum required number of players. The table management component 340 may record the comparison result in the game surveillance component for audit purposes.

At 538, the table management component 340 may close the table if the number of players is insufficient. The table management component 340 may update the table status to “closed” in the table management component 340. The table management component 340 may transmit the table closure status to the user's device for display. The table management component 340 may log the table closure event in the game surveillance component for traceability.

At 540, the table management component 340 may manage the table configuration based on the number of players and other parameters. The table management component 340 may update the table configuration to reflect the current player count and defined parameters. The table management component 340 may transmit the updated configuration to the game engine for synchronization. The table management component 340 may log the configuration updates in the game surveillance component for audit purposes.

At 542, the game engine may start the game once the table configuration is finalized. The game engine may retrieve the finalized table configuration from the table management component 340. The game engine may transmit the game start status to the user's device for display. The game engine may initiate the first round of gameplay based on the finalized configuration. The game engine may log the game start event in the game surveillance component for traceability.

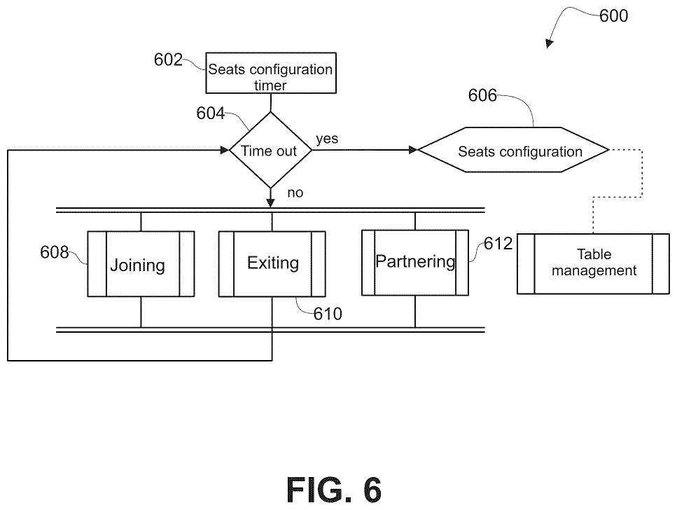

FIG. 6 illustrates a seats configuration flowchart 600 that supports techniques for synchronizing online gaming with secure transactions and real-time request management in accordance with various aspects of the present disclosure. Operations illustrated in the seats configuration flowchart 600 may involve a seats configuration timer 602, a joining component 608, an exiting component 610, and a partnering component 612, which may be examples of corresponding devices described herein. The seats configuration flowchart 600 may describe a process for managing seat assignments and transitions during gameplay based on timing and user actions. Seats configuration may be implemented in full game modes during a seat reconfiguration time of defined duration between 2 consecutive rounds.

At 602, the seats configuration timer may initiate a time frame for seat-related actions during gameplay. The seats configuration timer may define a specific duration during which players may send requests to join, exit, or partner at a table. The seats configuration timer may synchronize the timing of these actions with the server to ensure fairness among participants. The seats configuration timer may display a countdown on the user interface to inform players of the remaining time for seat-related actions. The seats configuration timer may adjust its duration based on the number of seats available at the table.

At 604, the seats configuration timer may reach a time-out condition, signaling the end of the seat adjustment period. The time-out condition may prevent players from sending new seat-related requests after the designated time frame has elapsed. The time-out condition may trigger the server to finalize the seating arrangement for the next round of gameplay. The time-out condition may be displayed on the user interface to notify players that the seat adjustment period has ended. The time-out condition may ensure that the game progresses without delays caused by pending seat-related actions.

At 606, the seats configuration timer may determine the updated seating arrangement for the next round of gameplay. The updated seating arrangement may reflect the addition of new players who successfully joined the table during the seat adjustment period. The updated seating arrangement may account for players who exited the table and are no longer participating in the game. The updated seating arrangement may include partnerships formed between players during the seat adjustment period. The updated seating arrangement may be displayed on the user interface to inform players of the current configuration of the table.

At 608, the joining component may include a process for adding new players to available seats at the table. The joining component may verify the wallet balance of a player to ensure sufficient funds to cover the gameplay wagers. The joining component may place the joining request in a queue if multiple players attempt to join the same table simultaneously. The joining component may lock the seat for the player once the joining request is accepted and processed. The joining component may update the table management component 340 to reflect the addition of the new player.

At 610, the exiting component may include a process for removing players from the table while maintaining the required number of participants. The exiting component may check the current number of seating players to ensure that at least two players remain at the table after the exit. The exiting component may calculate the refund amount for the exiting player based on the number of rounds completed and the casino commission. The exiting component may trigger a refund timer to delay the refund to the player's wallet for a specified duration. The exiting component may update the table management component 340 to reflect the removal of the exiting player.

At 612, the partnering component may include a process for forming partnerships between players during the seat adjustment period. The partnering component may prioritize flagged players who have indicated their openness to partnering with other players. The partnering component may verify the wallet balance of the requesting player to ensure sufficient funds for the partnership. The partnering component may refund the accepting player's wallet with the amount put on hold by the requesting player. The partnering component may update the table management component 340 to reflect the formation of the partnership.

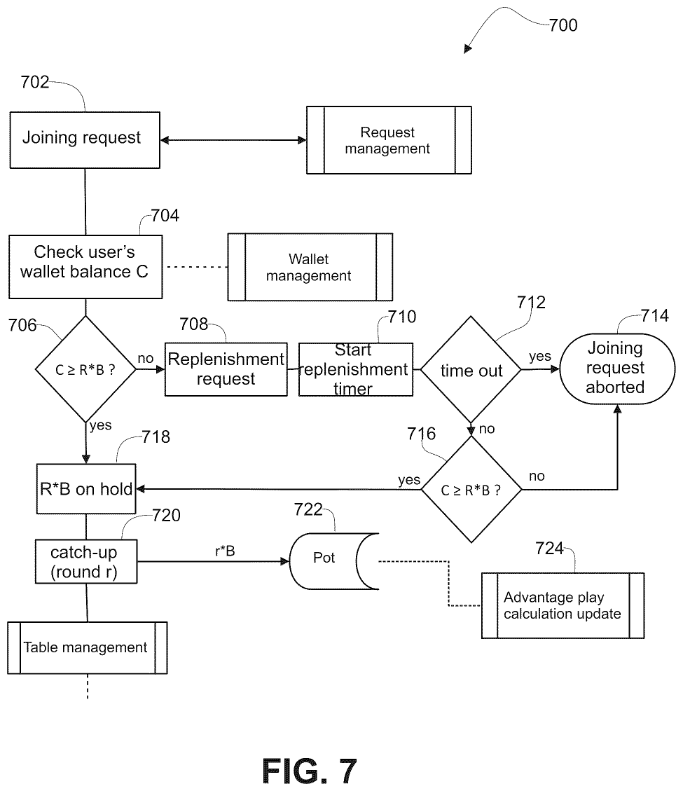

FIG. 7 illustrates a joining request flowchart 700 that supports techniques for synchronizing online gaming with secure transactions and real-time request management in accordance with various aspects of the present disclosure. Operations illustrated in the joining request flowchart 700 may involve a request management component, a wallet management component, a table management component 340, a pot management component, and an advantage play processing component, which may be examples of corresponding devices described herein. The joining request flowchart 700 may describe a process for verifying wallet balance, placing funds on hold, and managing game participation requests with provisions for times-out and advantage play updates.

At 702, the request management component may receive a joining request from a user. In some implementations, the joining request may include the user's unique identifier and the table identifier. The request management component may timestamp the joining request based on the synchronized game clock. The joining request may be queued at the table level according to the adjusted timestamp. The request management component may validate the joining request by checking whether the adjusted timestamp falls within the open time window for the table.

At 704, the wallet management component 336 may determine the user's wallet balance C. In some implementations, the wallet management component 336 may retrieve the wallet balance C from the user's account associated with the unique identifier. The wallet management component 336 may verify the integrity of the wallet balance data by consulting the ledger. The wallet management component 336 may ensure that the wallet balance C is accurately recorded in the system. The wallet management component 336 may transmit the wallet balance C to the request management component for further processing.

At 706, the wallet management component 336 may verify whether the wallet balance C is greater than or equal to R multiplied by B. In some implementations, the wallet management component 336 may determine the total number of rounds R and the standard wager B from the table management component 340. The wallet management component 336 may compute the product of R and B to determine the required amount for joining the table. The wallet management component 336 may compare the wallet balance C to the computed amount to verify sufficiency. The wallet management component 336 may flag the joining request as insufficient if the wallet balance C is less than the required amount.

At 708, the wallet management component 336 may initiate a replenishment request if the wallet balance C is insufficient. In some implementations, the wallet management component 336 may notify the user of the insufficient balance through the client interface. The wallet management component 336 may provide the user with options to replenish the wallet, such as credit card payment or other funding methods. The wallet management component 336 may lock the requested seat at the table while the replenishment request is pending. The wallet management component 336 may record the replenishment request in the ledger for traceability.

At 710, the wallet management component 336 may start a replenishment timer to allow the user to add funds to the wallet. In some implementations, the wallet management component 336 may determine the duration of the replenishment timer based on system settings. The wallet management component 336 may display the countdown of the replenishment timer on the user's client interface. The wallet management component 336 may monitor the replenishment timer to track the remaining time for the user to complete the funding process. The wallet management component 336 may transmit the replenishment timer status to the request management component for synchronization.

At 712, the wallet management component 336 may determine whether the replenishment timer has timed out. In some implementations, the wallet management component 336 may compare the current time to the end time of the replenishment timer. The wallet management component 336 may check whether the user has successfully added funds to the wallet before the timer expires. The wallet management component 336 may notify the request management component if the replenishment timer has timed out. The wallet management component 336 may record the times-out event in the ledger for audit purposes.

At 714, the request management component may abort the joining request if the replenishment timer has timed out without replenishment. In some implementations, the request management component may unlock the seat at the table associated with the aborted joining request. The request management component may notify the user of the aborted request through the client interface. The request management component may remove the aborted joining request from the queue at the table level. The request management component may update the table management component 340 to reflect the change in seat availability.

At 716, the wallet management component 336 may verify again whether the wallet balance C is greater than or equal to R multiplied by B after replenishment. In some implementations, the wallet management component 336 may retrieve the updated wallet balance C from the user's account. The wallet management component 336 may recompute the required amount for joining the table based on R and B. The wallet management component 336 may compare the updated wallet balance C to the required amount to confirm sufficiency. The wallet management component 336 may proceed with the joining process if the updated wallet balance C meets the condition.

At 718, the wallet management component 336 may place the amount R multiplied by B on hold in the user's wallet. In some implementations, the wallet management component 336 may associate the amount on hold with the unique table identifier and the user's wallet identifier. The wallet management component 336 may record the amount on hold in the ledger for traceability. The wallet management component 336 may notify the user of the amount placed on hold through the client interface.

At 720, the table management component 340 may cooperate with the wallet management component 336 to process the catch-up requirement for the user joining the game at round r. In some implementations, the table management component 340 may determine the number of missed rounds r−1 for the user joining the game. The table management component 340 may compute the catch-up amount r multiplied by B (r*B) based on the missed rounds and the standard wager. The table management component 340 may update the user's status in the seating player list to reflect the catch-up requirement. The table management component 340 may transmit the catch-up amount to the pot management component for further processing.

At 722, the pot management component may update the pot with the catch-up amount r multiplied by B. In some implementations, the pot management component may retrieve the current pot value Wr from the table management component 340. The pot management component may add the catch-up amount r multiplied by B to the current pot value Wr. The pot management component may record the updated pot value in the ledger for audit purposes. The pot management component may notify the advantage play processing component of the updated pot value for synchronization.

At 724, the advantage play processing component may update the advantage play calculation based on the updated pot value and odds of winning. In some implementations, the advantage play processing component may retrieve the updated pot value Wr from the pot management component. The advantage play processing component may determine the advantage play trigger T based on the card deck composition. The advantage play processing component may compare the ratio Wr/B to the advantage play trigger T to determine whether advantage play conditions are met. The advantage play processing component may transmit the advantage play status to the table management component 340 for display on the client interface.

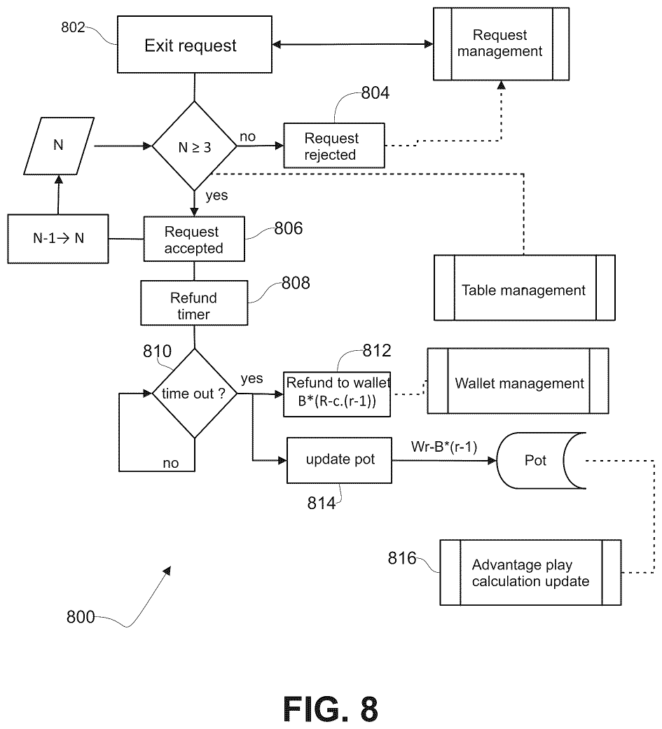

FIG. 8 illustrates a decision-making flowchart 800 for an exit request that supports techniques for synchronizing online gaming with secure transactions and real-time request management in accordance with various aspects of the present disclosure. Operations illustrated in the decision-making flowchart 800 may involve a request management component, a table management component 340, a pot management component, a wallet management component, and an advantage play processing component, which may be examples of corresponding devices described herein. The decision-making flowchart 800 may describe a process for handling exit requests, determining their acceptance or rejection, managing refunds, updating pots, and recalculating advantage play parameters.

At 802, the request management component may receive an exit request from a player participating in a table. The request management component may retrieve the unique identifier of the table associated with the exit request to confirm the table's current configuration. The request management component may determine the adjusted timestamp of the exit request to verify its validity within the seat reconfiguration time frame. The request management component may consult the table management component 340 to identify the number of players currently seated at the table. The request management component 802 may record the exit request in a ledger with the adjusted timestamp and the player's unique identifier.

At 804, the request management component may with the table management component 340 and reject the exit request if the conditions for acceptance are not met. The request management component may determine whether the number of players remaining at the table after the exit would fall below the threshold of two. The request management component may verify whether the adjusted timestamp of the exit request falls outside the seat reconfiguration time frame. The request management component may consult the table management component 340 to confirm whether the player requesting the exit has been seated at the table for at least one round. The request management component may record the rejection of the exit request in the game surveillance component for further analysis.

At 806, the request management component may accept the exit request if the conditions for acceptance are satisfied. The request management component may update the table management component 340 to reflect the reduced number of players seated at the table. The table management component 340 may flag the exiting player's seat as unoccupied for the next round. The request management component may record the acceptance of the exit request in the ledger with the adjusted timestamp and the player's unique identifier. The request management component may notify the wallet management component 336 to prepare for the refund process.

At 808, the request management component may initiate a refund timer to delay the refund process for the exiting player. The delay in the refund may aim at preventing players from jumping from one table to another and degrading the gaming experience of the other players. In some implementations, the refund timer may last at least as long as the seat reconfiguration timer. The request management component may record the start time and end time of the refund timer in the ledger associated with the table's unique identifier. The request management component may notify the wallet management component 336 of the refund timer's duration to synchronize the refund process. The request management component may monitor the refund timer to ensure its completion before initiating the refund.

At 810, the request management component may determine whether the refund timer has timed out. The request management component may compare the current server time with the recorded end time of the refund timer. The request management component may consult the game clock component to verify synchronization between the server and the client. The request management component may notify the wallet management component 336 if the refund timer has timed out. The request management component may record the completion of the refund timer in the ledger associated with the table's unique identifier.

At 812, the wallet management component 336 may refund the exiting player's wallet with an amount determined by B*(R−c*(r−1)) where r is the number of the current round and c the casino commission in percentage. The wallet management component 336 may retrieve the player's unique identifier and wallet identifier from the ledger to process the refund. The wallet management component 336 may determine the casino commission percentage c from the table management component 340. The wallet management component 336 may calculate the refund amount based on the number of rounds completed r and the total number of rounds R. The wallet management component 336 may update the player's wallet balance to reflect the refunded amount.

At 814, the pot management component may update the pot by subtracting the refunded amount B*(r−1) from the current pot value Wr. The pot management component may retrieve the current pot value Wr from the table management component 340. The pot management component may determine the number of rounds completed r to calculate the amount to be subtracted. The pot management component may update the table management component 340 to reflect the new pot value. The pot management component may record the updated pot value in the ledger associated with the table's unique identifier.

At 816, the advantage play processing component may determine updated advantage play parameters based on the new pot value Wr. The advantage play processing component may retrieve the updated pot value Wr from the pot management component. The advantage play processing component may determine the number of standard wagers B required to trigger advantage play. The advantage play processing component may consult the table management component 340 to retrieve the current card deck composition. The advantage play processing component may update the advantage play indicator in the table management component 340 based on the recalculated parameters.

In some implementations exit requests are processed on a first-come first-served and a first-in, first-out basis. Fo instance, when only three players are seating at a table and two of these three players make an exist request, only one exist request may be accepted, since at least two players are required for the game to continue. According to the first-come first-served principle, the request management component may cooperate with the queue management component to determine which of the two requests has the earliest adjusted timestamp and the player having sent such an earlier request may be prioritized for exit. In a case where the exit requests of the two players have the same adjusted timestamp, the request management component may cooperate with the table management component 340 to define which of the two players joined the table earlier. According to the first-in first-out principle the player having joined the table earlier may have his exit request accepted while the other player may have his exit request rejected. In a case where the adjusted timestamps of the exit requests of the two players are the same and the table joining adjusted timestamp of the player are also the same the request management component may record the event in the game surveillance component as a suspicious event for further analysis.

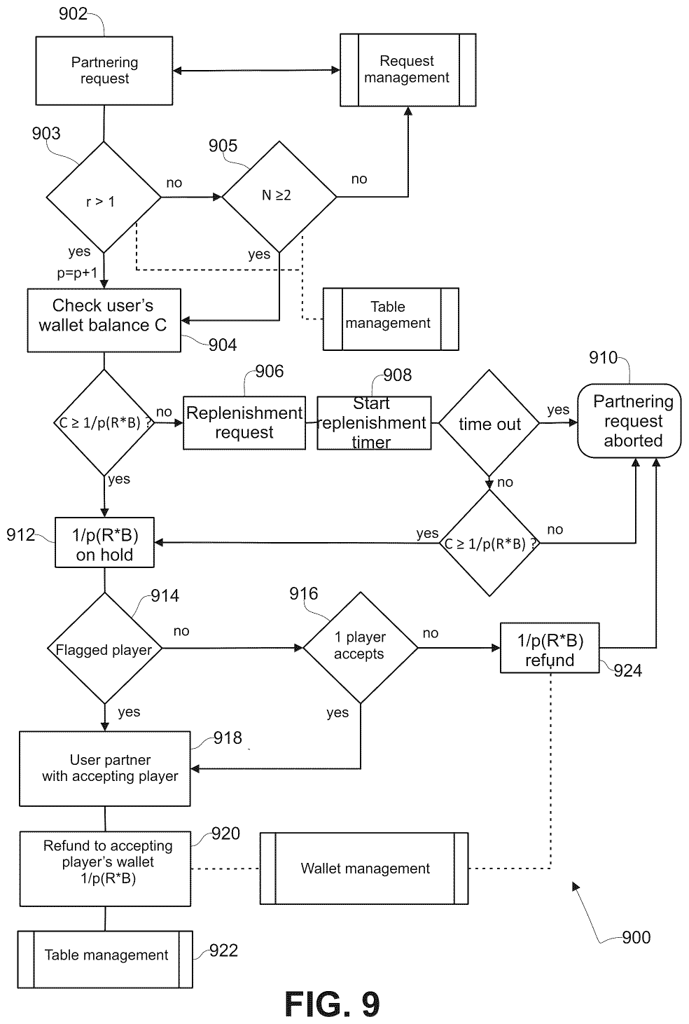

FIG. 9 illustrates a partnering request flowchart 900 that supports techniques for synchronizing online gaming with secure transactions and real-time request management in accordance with various aspects of the present disclosure. Operations illustrated in the partnering request flowchart 900 may involve a request management component, a wallet management component, a partnering request processing component 332, and a table management component 340, which may be examples of corresponding devices described herein. The partnering request flowchart 900 may describe a process for managing partnering requests, verifying wallet balances, handling replenishment, and facilitating user partnerships or refunds based on the acceptance of requests.

At 902, the request management component may receive a partnering request from a user. In some implementations, the partnering request may include the user's unique identifier and the table identifier. The request management component may timestamp the partnering request upon receipt to ensure accurate processing. The partnering request may be queued in the request management component based on the timestamp and the first-come, first-served principle. The partnering request may be validated by the request management component to confirm that it falls within the open time frame for seat reconfiguration.

In some implementations, a partnering request to a table may be processed before the first round of the game (r=1) provided that there are at least two players seating at the table and the table is not close. The request management component may cooperate with the table management component 340 to check if the conditions are met and accept or reject the partnering request accordingly.

At 903 the request management component may cooperate with the table management component 340 to determine if the table is in the generation stage (r=1) or in a seats reconfiguration state (r>1), r being the current round number.

At 905, if the table is in the generation stage the request management component may cooperate with the table management component 340 to check if there is at least two players seating at the table (N≥2), if the condition is verified the partnering request processing moves forward, if the condition is not met the request management component may recheck the condition form time to time until the first run starts at the table as players may join the table.

At 904, the wallet management component 336 may determine the user's wallet balance C to verify whether it meets the partnering requirements. In some implementations, the wallet management component 336 may retrieve the user's wallet balance from a ledger associated with the user's unique identifier. The partnering requirements may involve verifying that the wallet balance C is equal to or greater than 1/p(R*B), where R is the total number of rounds, B is the standard wager, and p is the number of partners allowed per seat. The wallet management component 336 may check the association between the user's wallet and the partnering request to ensure consistency. The wallet management component 336 may flag the partnering request for further processing if the wallet balance meets the requirements. The number of partners allowed per seat may be capped to a maximum number such as two or three. The partner position at the seat may be locked during the balance check.

At 906, the wallet management component 336 may initiate a replenishment request if the user's wallet balance C is insufficient. In some implementations, the replenishment request may prompt the user to add funds to their wallet through a secure transaction. The wallet management component 336 may display the amount required to meet the partnering requirements on the user's interface. The replenishment request may include a timer to track the time available for the user to complete the replenishment. The wallet management component 336 may record the replenishment request in a ledger for traceability.

At 908, the wallet management component 336 may start a replenishment timer to allow the user to add funds to their wallet. In some implementations, the replenishment timer may be displayed on the user's interface to indicate the remaining time for replenishment. The wallet management component 336 may synchronize the replenishment timer with the server clock to ensure accurate timing. The replenishment timer may be set to a predefined duration based on the system configuration. The wallet management component 336 may monitor the replenishment timer and update the partnering request status accordingly.

At 910, the request management component may abort the partnering request if the replenishment timer expires without sufficient funds being added. In some implementations, the request management component may notify the user of the aborted partnering request through the user's interface. The aborted partnering request may be removed from the queue in the request management component. The request management component 910 may record the aborted partnering request in the game surveillance component for analysis. The request management component may unlock the flagged seat at the table for other users to send partnering requests.

At 912, the wallet management component 336 may place 1/p(R*B) on hold from the user's wallet balance for the partnering request. In some implementations, the wallet management component 336 may associate the amount on hold with the user's unique identifier and the table identifier. The amount on hold may be recorded in a ledger to ensure traceability of the transaction. The wallet management component 336 may update the user's wallet balance to reflect the amount placed on hold. The wallet management component 336 may notify the user of the updated wallet balance through the user's interface.

At 914, the partnering request processing component 332 may identify a flagged player at the table who is open to partnering. In some implementations, the flagged player may be identified based on the table configuration stored in the table management component 340. The partnering request processing component 332 may prioritize flagged players over other players at the table for partnering requests. The flagged player may be notified of the partnering request through the table interface. The partnering request processing component 332 may validate the flagged player's status before proceeding with the partnering request.

At 916, the partnering request processing component 332 may process the acceptance of the partnering request by one player at the table. In some implementations, the acceptance may involve the flagged player clicking a partnering accept button on the table interface. The partnering request processing component 332 may update the partnering request status to reflect the acceptance. The acceptance may be recorded in a ledger with the adjusted timestamp for traceability. The partnering request processing component 332 may notify the user of the acceptance through the user's interface.

At 918, the partnering request processing component 332 may establish a partnership between the user and the accepting player. In some implementations, the partnership may be treated as a single player for the game. The partnering request processing component 332 may update the table configuration to reflect the partnership. The partnership may be recorded in the table management component 340 with the unique identifiers of both partners. The partnering request processing component 332 may notify both partners of the established partnership through their respective interfaces.

At 920, the wallet management component 336 may refund 1/p(R*B) to the accepting player's wallet as part of the partnering process. In some implementations, the refund may be associated with the accepting player's unique identifier and the table identifier. The wallet management component 336 may update the accepting player's wallet balance to reflect the refunded amount. The refund may be recorded in a ledger for traceability. The wallet management component 336 may notify the accepting player of the updated wallet balance through the table interface.

At 922, the table management component 340 may update the table configuration to reflect the new partnership. In some implementations, the table management component 340 may update the seating arrangement to include the partnership. The table configuration may be recorded in a ledger with the adjusted timestamp for traceability. The table management component 340 may notify all players at the table of the updated configuration through the table interface. The table management component 340 may synchronize the updated configuration with the server clock to ensure accurate timing.

At 924, the wallet management component 336 may refund 1/p(R*B) to the user's wallet if the partnering request is aborted. In some implementations, the refund may be associated with the user's unique identifier and the table identifier. The wallet management component 336 may update the user's wallet balance to reflect the refunded amount. The refund may be recorded in a ledger for traceability. The wallet management component 336 may notify the user of the updated wallet balance through the user's interface.

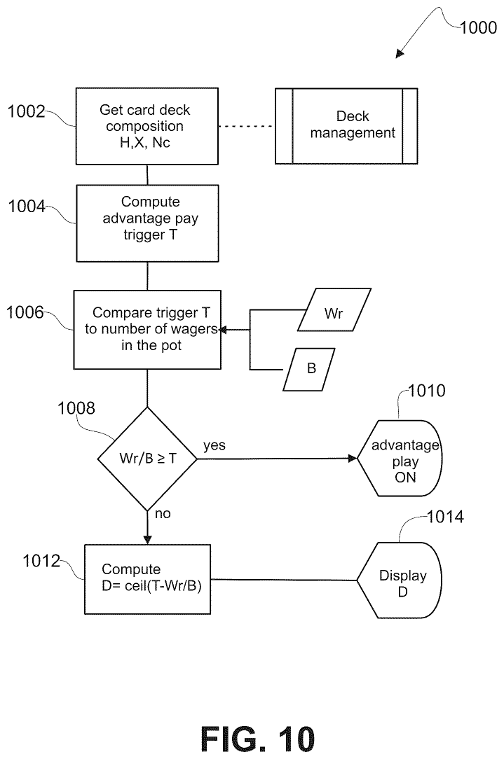

FIG. 10 illustrates an advantage play flowchart 1000 that supports techniques for synchronizing online gaming with secure transactions and real-time request management in accordance with various aspects of the present disclosure. Operations illustrated in the advantage play flowchart 1000 may involve an advantage play processing component 334, a deck management component 324 and a pot management component 338, and/or other components, which may be examples of corresponding devices described herein. The advantage play flowchart 1000 may describe a process for determining when to activate advantage play based on the relationship between wagers in the pot and a computed trigger value, and for displaying the required adjustment if the condition is not met.

At 1002, the advantage play processing component may determine the card deck composition, including the number of half pot cards (H), build cards (X), and total cards (Nc) with Nc=H+X. In some implementations, the advantage play processing component 334 may retrieve the card deck composition from a deck management component 324 that tracks the distribution of cards across rounds. The card deck composition may vary depending on whether the game is in standard full mode or advanced full mode, with the latter mode requiring adjustments after each round. The advantage play processing component 334 may identify the number of half pot cards (H) and build cards (X) remaining in the deck after the previous round. The total number of cards (Nc) in the deck may be determined by summing the values of H and X.

At 1004, the advantage play processing component may determine the advantage play trigger value (T) based on the card deck composition. In some implementations, the advantage play processing component 334 may use the formula T=((H−1)/(NC−1))/(H/NC) to determine the trigger value. The trigger value (T) may represent the threshold ratio of wagers required in the pot to activate advantage play. The advantage play processing component 334 may compute T dynamically for each round in advanced full mode, reflecting changes in the card deck composition. For example, if the deck contains 10 half pot cards (H) and 40 build cards (X), resulting in a total of 50 cards (NC), the trigger value (T) may be determined as 27.22.

At 1006, the advantage play processing component may cooperate with the pot management component to compare the computed trigger value (T) to the number of wagers currently in the pot. In some implementations, the pot management component 338 may retrieve the current pot value (Wr) from the table management component 340, which tracks wagers across rounds. The pot management component 338 may divide the pot value (Wr) by the standard wager amount (B) to determine the ratio of wagers in the pot. The computed trigger value (T) may be compared to the ratio Wr/B to assess whether the condition for advantage play activation is met. For example, if the pot contains $300 and the standard wager is $10, the ratio Wr/B may be determined as 30.

At 1008, the advantage play processing component may determine whether the ratio of wagers in the pot (Wr/B) meets or exceeds the computed trigger value (T). In some implementations, the advantage play processing component may evaluate the condition Wr/B≥T to decide whether advantage play should be activated. If the ratio Wr/B is equal to or greater than the trigger value (T), the condition may be satisfied, and the advantage play processing component may proceed further. For example, if the computed trigger value (T) is 27.22 and the ratio Wr/B is 30, the condition Wr/B≥T may be satisfied.

At 1010, the advantage play processing component may activate the advantage play indicator when the condition Wr/B≥T is satisfied. In some implementations, the advantage play processing component 334 may update the table management component 340 to reflect the activation of advantage play. The advantage play indicator may be displayed on the user interface of all players participating in the game, signaling that the payout odds are greater than the odds of winning. The advantage play processing component 334 may ensure that the indicator remains active for the duration of the round in which the condition Wr/B≥T is satisfied. For example, the advantage play indicator may light up on the table interface when the pot value exceeds the computed trigger value.

At 1012, the advantage play processing component may determine the number of additional wagers (D) required to meet the advantage play trigger value if the condition Wr/B≥T is not satisfied. In some implementations, the advantage play processing component 334 may compute the value of D using the formula D=ceil(T−WR/B), where the function “ceil” rounds up to the nearest integer. The computed value of D may represent the number of standard wagers needed to reach the trigger value (T) for advantage play activation. The advantage play processing component 334 may retrieve the current pot value (Wr) and standard wager amount (B) from the pot management component to determine D. For example, if the trigger value (T) is 27.22 and the ratio Wr/B is 24, the computed value of D may be determined as 4.

At 1014, the advantage play processing component may display the computed value of D to indicate the number of wagers needed to activate advantage play. In some implementations, the advantage play processing may update the user interface of all players participating in the game to display the value of D. The displayed value of D may inform players of the additional wagers required to reach the advantage play trigger value (T) in the next round. The advantage play processing component may ensure that the displayed value of D is synchronized across all devices connected to the game server. For example, the user interface may show “Wagers to advantage play: 4” when the computed value of D is 4.

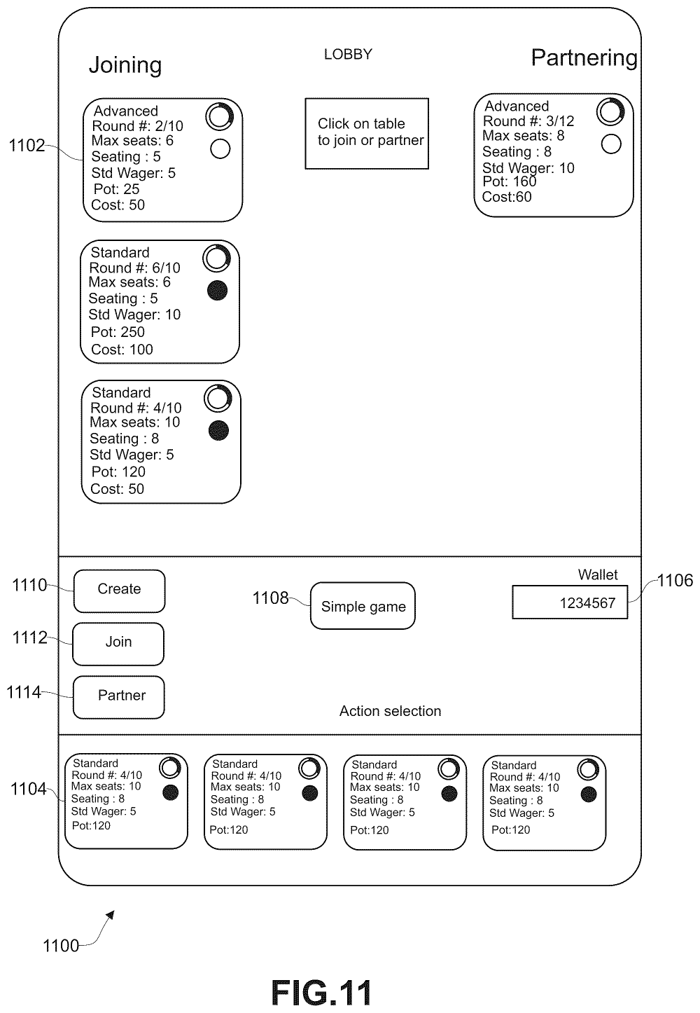

FIG. 11 shows game lobby interface 1100 which supports techniques for synchronizing online gaming with secure transactions and real-time request management in accordance with various aspects of the present disclosure. As depicted in FIG. 11, the game lobby interface 1100 may include one or more of tables widgets 1102, player's participating tables widgets 1104, a wallet indicator 1106, a simple game button 1108, a create button 1110, a join button 1112, a partner button 1114, and/or other components.

The tables widgets 1102 may include information about available tables, such as table names, game types, round numbers, and other relevant details. The tables widgets 1102 may display the number of players currently seated at a table and the total number of seats available. The tables widgets 1102 may further indicate the current pot size and the number of rounds completed or remaining in the game. In some implementations, the tables widgets 1102 may include a timer showing the time left for players to join or make decisions during the seat reconfiguration step. The tables widgets 1102 may be presented in a grid or list format, and alternative designs may include filters for sorting tables by criteria such as wager amounts or advantage play status.

The player's participating table widgets 1104 may represent the tables where the player is currently engaged in ongoing games. The player's participating tables widgets 1104 may display the table names, the current round numbers, and the pot sizes for each table. The player's participating tables widgets 1104 may further show the player's seat number and any partnering status at the table. In some implementations, the player's participating tables widgets 1104 may include indicators for advantage play status or timers for upcoming seat reconfiguration steps. The player's participating tables widgets 1104 may be organized in a separate section of the user interface, and alternative layouts may include collapsible panels for each table.

The wallet indicator 1106 may display the current balance of the player's wallet for managing wagers and transactions. Information displayed by the wallet indicator 1106 reflects a user's wallet status in the wallet management component 336, as described herein.

The simple game button 1108 may allow the player to access a simplified single-player game mode implemented by the simple game component 326, as described herein.

The create button 1110 may enable the player to initiate the creation of a new table with customizable parameters. The create button 1110 may allow the player to specify the number of seats, the number of rounds, and the standard wager amount for the table. The create button 1110 may further enable the player to select the game type, such as standard full game or advanced full game. The create button 1110 causes the user client to send a table creation request. Such a request may trigger a wallet balance check to ensure the player has sufficient funds to cover the game. The create button 1110 may be displayed prominently in the user interface, and alternative implementations may include a confirmation dialog before finalizing the table creation.

The join button 1112 may allow the player to view and join tables with available seats during the game. The join button 1112 may display a list of tables that meet the player's criteria, such as wager amounts or advantage play status. The player may select a table in the displayed list of tables, by clicking on a table widget 1102, causing the user client to send a joining request to the server. The join button 1112 may be located in the lobby interface, and alternative designs may include a search bar for finding specific tables.

The partner button 1114 may provide the player with the option to view tables, as table widgets, based on selection criteria. The player may send a request for partnership at a selected table by clicking on the selected table widget 1102, causing the user client to send a partnering request which may be processed by the partnering request processing component 332, as described herein.

In some implementations, the table widgets 1102 may be arranged in the lobby interface to display a list of available tables, with each widget presenting details such as the game type, round number, maximum seats, current seating, standard wager, pot value, and joining cost. The player's participating tables widgets 1104 may be positioned in a separate area of the lobby interface to show tables where the user is actively engaged, allowing quick navigation to the corresponding table interfaces. The wallet indicator 1106 may be located prominently within the lobby interface to display the current balance of the user's wallet, which may update dynamically based on game outcomes and transactions.

In some implementations, the simple game button 1108 may be situated near the action selection area, enabling users to access a simplified game mode directly from the lobby. The create button 1110 may be positioned alongside the join button 1112 and the partner button 1114, forming a cluster of controls that may allow users to initiate table creation, request to join a table, or request to partner with another player.

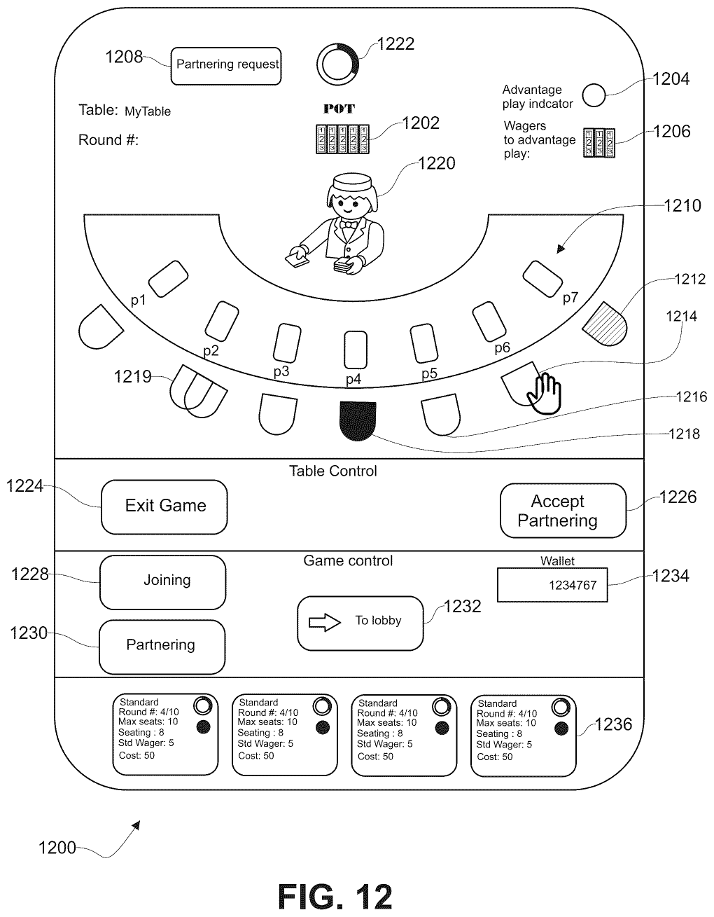

FIG. 12 shows gaming interface illustration 1200 which supports techniques for synchronizing online gaming with secure transactions and real-time request management in accordance with various aspects of the present disclosure. As depicted in FIG. 12, the gaming interface illustration 1200 may include one or more of a pot display 1202, an advantage play indicator 1204, wagers to advantage play indicator 1206, a partnering request indicator 1208, a card distribution area 1210, a free seat 1212, a player open to partnering seat 1214, an occupied seat 1216, a current player seat 1218, a seat with a partnership 1219, a dealer 1220, a timer 1222, an exit game button 1224, an accept partnering button 1226, a joining button 1228, a partnering button 1230, a to lobby button 1232, a wallet display 1234, player's participating tables widgets 1236, and/or other components.

The pot display 1202 may include a visual representation of the accumulated wagers for the current game round. The pot display 1202 may visually represent the total wagers contributed by players up to the current round. In some implementations, the pot display 1202 may include graphical elements such as chips or numerical values to represent the pot's content.

The advantage play indicator 1204 may represent whether the payout odds exceed the odds of winning based on the current game state. The advantage play indicator 1204 may visually signal to players when the accumulated wagers surpass the threshold determined from the card deck composition. The advantage play indicator 1204 may display information derived from the advantage play processing component. In some implementations, the advantage play indicator 1204 may include color changes or icons to signify its status.

The wagers to advantage play indicator 1206 may display the number of additional wagers required to trigger the advantage play condition. The wagers to advantage play indicator 1206 may dynamically update based on the current pot size and the advantage play threshold. In some implementations, the wagers to advantage play indicator 1206 may include numerical values or progress bars to represent the required wagers.

The partnering request indicator 1208 may provide a visual cue when a partnering request has been sent to the table. The partnering request indicator 1208 may visually notify players of incoming requests for partnership during the seat reconfiguration phase. The partnering request indicator 1208 may interact with the accept partnering button 1226 to allow players to respond to partnership requests. In some implementations, the partnering request indicator 1208 may include flashing icons or text prompts to signal the request.

The card distribution area 1210 may depict the arrangement of players, seats, at the virtual table. The card distribution area 1210 may visually represent the seating configuration during gameplay, here players p. 1 . . . p7. The card distribution area 1210 may include graphical representations of cards to simulate a physical casino table.

The free seat 1212 may represent an unoccupied position available, for a player to join the table. The free seat 1212 may visually indicate the availability of a position, here p7, for new players during the seat reconfiguration phase. In some implementations, the free seat 1212 may include graphical elements such as empty chairs or placeholders to signify its status.

The player open to partnering 1214 may indicate a player who has flagged their availability for a partnership. The player open to partnering 1214 may visually signal to other players that a partnership request can be initiated. In some implementations, the player open to partnering 1214 may include icons or text labels to represent the player's status.

The occupied seat 1216 may represent a position currently taken by a player participating in the game. The occupied seat 1216 may visually display the presence of a player and their associated actions during gameplay. In some implementations, the occupied seat 1216 may include graphical elements such as avatars or player names to signify its status.

The current player seat 1218 shows the user position at the table. In some implementations, the current player seat 1218 may include graphical elements such as avatars, chips, and cards to simulate a physical casino table.

The dealer 1220 may represent the virtual dealer responsible for managing the game. The dealer 1220 may visually display the card distribution sequence. In some implementations, the dealer 1220 may include graphical representations such as animated characters or icons to simulate a physical dealer.

The timer 1222 may display the remaining time for actions that may take place during seat reconfiguration or table creation. The timer 1222 may visually indicate the countdown for players to complete their actions during the aforementioned phases. In some implementations, the timer 1222 may include graphical elements such as progress bars or numerical countdowns to represent the remaining time.

The exit game button 1224 may allow a player to cause the user client to send an exit request to leave the game during the seat reconfiguration phase. The exit game button 1224 may visually enable players to initiate an exit request from the table. In some implementations, the exit game button 1224 may include text labels or icons to represent its function.

The accept partnering button 1226 may enable a player to confirm a partnership request during the seat reconfiguration phase. The accept partnering button 1226 may visually allow players to respond to incoming partnership requests. The accept partnering button 1226 may interact with the partnering request indicator 1208 to facilitate the acceptance process. In some implementations, the accept partnering button 1226 may include graphical elements such as checkmarks or text prompts to signify its function.

The joining button 1228 may allow a player to initiate a request to join a table with available seats. In some implementations, the joining button 1228 may be the same as or similar to the join button 1112, as described herein.

The partnering button 1230 may enable a player to initiate a request for partnering to a table. In some implementations, the partnering button 1230 may be the same as or similar to the partner button 1114, as described herein.

The to lobby button 1232 may provide a way for the player to navigate back to the lobby interface. The to lobby button 1232 may visually allow players to return to the lobby to explore other tables or game options. In some implementations, the to lobby button 1232 may include graphical elements such as arrows or text labels to represent its function.

The wallet display 1234 may show the current balance available in the player's wallet. The wallet display 1234 may visually represent the player's available funds for wagering and game actions. In some implementations, the wallet display 1234 may include numerical values or graphical representations such as currency symbols to signify the wallet's content.

The player's participating tables widgets 1236 may display information about the tables where the player is currently active. In some implementations, the player's participating tables widgets 1236 may be the same as or similar to the player's participating tables widgets 1104, as described herein.

In some implementations, the pot display 1202 may be positioned at the top center of the table interface to visually represent the accumulated wagers for the ongoing round. The advantage play indicator 1204 may be located adjacent to the pot display 1202 and may signify when the payout odds exceed the odds of winning. The wagers to advantage play indicator 1206 may be displayed nearby to indicate the number of wagers required to trigger the advantage play condition. The partnering request indicator 1208 may be situated prominently to alert players when a partnering request has been sent to the table.

In some implementations, the gaming interface may depict the dealer 1220 at the center of a table, surrounded by graphical representations of player seats, including free seats 1212, occupied seats 1216, player seats 1218 and seats with partnership 1219. A player open to partnering 1214 may be visually distinguished within the table distribution area 1210 to indicate their availability for partnership. The timer 1222 may be displayed as an animated element to represent the time remaining for seat reconfiguration or other game phases.

In some implementations, the table control area may include an exit game button 1224, which may allow players to leave the table, and an accept partnering button 1226, which may enable players to confirm a partnering request. The game control area may feature a joining button 1228 and a partnering button 1230, which may allow players to initiate a joining or partnering request after selecting a target table. The to lobby button 1232 may provide a navigation option to return to the lobby interface. The wallet display 1234 may show the current balance of the player's wallet, while the player's participating tables widgets 1236 may list the tables where the player is actively engaged, offering quick access to those games.

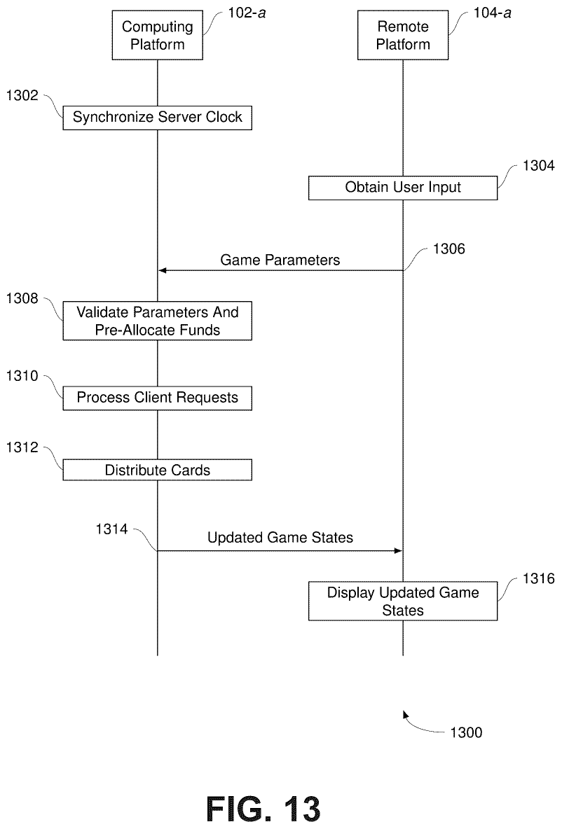

FIG. 13 illustrates an example of a process flow 1300 for synchronizing online gaming with secure transactions and real-time request management in accordance with aspects of the present disclosure. In some examples, the process flow 1300 may implement aspects of the system 100. For example, the process flow 1300 may include a computing platform 102-a (e.g., a server) and a remote platform 104-a (e.g., a user device), which may be examples of corresponding devices described herein. In some implementations, a computing platform 102-a synchronizes its server clock with a remote platform 104-a's game clock, processes timestamp validated client requests from the remote platform 104-a in real-time, manages a wallet associated with the remote platform 104-a by pre-allocating funds and recording transactions in an unalterable ledger, and distributes cryptographically secure random cards to the remote platform 104-a for gameplay.

At 1302, the computing platform 102-a may synchronize its server clock with the game clock of the remote platform 104-a by performing a ping-pong process to compute round-trip time and adjust timestamps for client requests. For example, the computing platform 102-a may determine the latency between itself and the remote platform 104-a by measuring the time taken for a ping signal to travel to the remote platform 104-a and for the corresponding pong signal to return. In some implementations, the computing platform 102-a may adjust the timestamps of client requests by applying the determined latency to the original timestamps sent by the remote platform 104-a.

At 1304, the remote platform 104-a may obtain user input for initiating a wager accumulation game, including parameters such as the number of players, rounds, and standard wager amount. For example, the remote platform 104-a may display a user interface where the user may select from predefined combinations of players and rounds, such as 4players with 8 rounds or 6 players with 10 rounds. In some implementations, the remote platform 104-a may allow the user to input a custom standard wager amount within a range, such as $5 to $25, based on local regulations. The remote platform 104-a may further prompt the user to confirm their selections before proceeding to the next step.

At 1306, the remote platform 104-a may transmit the user input, including the game parameters, to the computing platform 102-a. For example, the remote platform 104-a may send data strings representing the selected number of players, rounds, and standard wager amount to the computing platform 102-a for processing. In some implementations, the remote platform 104-a may transmit additional parameters, such as the table identifier or user preferences for game modes, to the computing platform 102-a. In other implementations, the remote platform 104-a may include a timestamp with the transmitted user input to align the game progression with the server clock of the computing platform 102-a.

At 1308, the computing platform 102-a may validate the transmitted game parameters, may pre-allocate funds in the wallet associated with the remote platform 104-a, and may record the pre-allocation in an unalterable ledger. For example, the computing platform 102-a may verify that the transmitted game parameters align with predefined rules, such as ensuring the selected number of players and rounds fall within allowable ranges. In some implementations, the computing platform 102-a may pre-allocate funds by reserving an amount equivalent to the total potential wagers for the game, based on the transmitted parameters. In other implementations, the computing platform 102-a may record the pre-allocation in a ledger by associating the reserved funds with a unique table identifier and the user's wallet identifier.

At 1310, the computing platform 102-a may process client requests by validating adjusted timestamps, queuing the requests based on a first-come, first-served principle, and prioritizing the requests in real-time according to the adjusted timestamps. For example, the computing platform 102-a may reject requests if the difference between the adjusted timestamp and the recorded reception time exceeds a tolerance threshold. In some implementations, the computing platform 102-a may assign a unique identifier to each request and sort the requests within the queue based on the adjusted timestamps to maintain fairness. In other implementations, the computing platform 102-a may record the adjusted timestamps and associated request details in a ledger for traceability.

At 1312, the computing platform 102-a may distribute cards for gameplay by generating random numbers through a cryptographically secure random number generator and updating game states based on the distributed cards. For example, the computing platform 102-a may determine the sequence of card distribution by assigning random values to each card in the deck and sorting them accordingly. In some implementations, the computing platform 102-a may associate the distributed cards with specific player identifiers to track individual game progress. In other implementations, the computing platform 102-a may log the distributed cards and their corresponding random values in a ledger for traceability.

At 1314, the computing platform 102-a may transmit the updated game states, including the distributed cards and pot information, to the remote platform 104-a. For example, the computing platform 102-a may send a data stream containing parameters for animations, such as card distribution sequences and pot updates, to the remote platform 104-a for display. In some implementations, the computing platform 102-a may include timestamps for the start and end of the round within the transmitted game states to align animations on the remote platform 104-a with the server clock. In other implementations, the computing platform 102-a may transmit player-specific data, such as seat positions and card outcomes, to the remote platform 104-a to ensure accurate visualization of the game progression.

In a nonlimiting example a parameter string sent by the computing platform 102-a to be interpreted by the remote platform 104-a to generate an animation from the parameterized animation bank, may comprise a string of parameters comprising: a start date and a end date for the animation, a card distribution sequence among seating players such as (p3: x, p4: x, p5: x, p6: x, p. 1: x, p2: x, p4: h, p4: x) where pn: x or h means player pn receives a build card x or an half pot card h, a start date and an end date for the seat reconfiguration.

At 1316, the remote platform 104-a may display the updated game states, including animations of the card distribution and pot updates, to the user. For example, the remote platform 104-a may render an animation showing a dealer distributing cards to virtual seats, with the sequence and timing based on parameters received from the computing platform 102-a. In some implementations, the remote platform 104-a may include visual indicators, such as highlighting a winning seat or flashing the pot value, to emphasize key outcomes of the round. In other implementations, the remote platform 104-a may display a timer animation to indicate the transition period before the next round begins, synchronized with the timestamps provided by the computing platform 102-a.

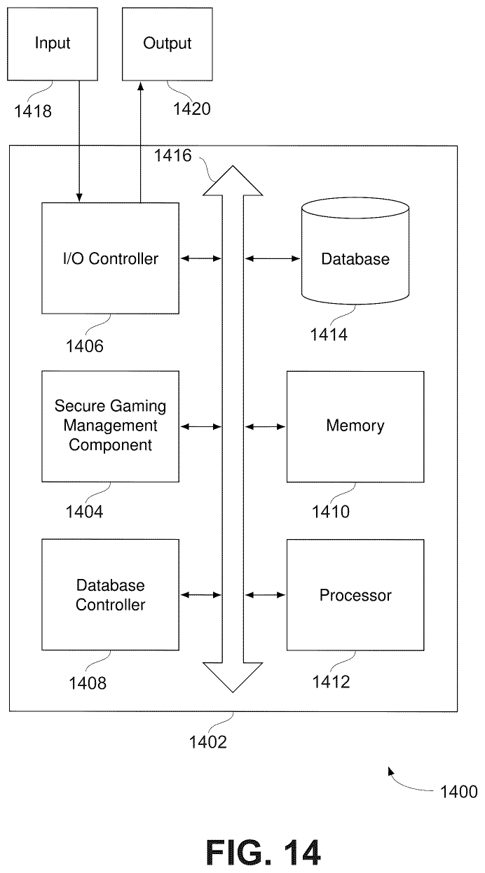

FIG. 14 shows a diagram of a system 1400 including a device 1402 configured for synchronizing online gaming with secure transactions and real-time request management in accordance with aspects of the present disclosure. The device 1402 may be an example of or include the components of a computing platform 102 and a remote platform 104 as described herein. The device 1402 may include components for bidirectional data communications including components for transmitting and receiving communications, including a secure gaming management component 1404, an I/O controller 1406, a database controller 1408, memory 1410, a processor 1412, and a database 1414. These components may be in electronic communication via one or more buses (e.g., bus 1416).

The secure gaming management component 1404 may be an example of one or more components of the system 100 as described herein. For example, the secure gaming management component 1404 may perform any of the methods or processes described above with reference to machine-readable instructions 106 in connection with FIG. 1. In some cases, the secure gaming management component 1404 may be implemented in hardware, software executed by a processor, firmware, or any combination thereof.

The I/O controller 1406 may manage input signals 1418 and output signals 1420 for the device 1402. The I/O controller 1406 may also manage peripherals not integrated into the device 1402. In some cases, the I/O controller 1406 may represent a physical connection or port to an external peripheral. In some cases, the I/O controller 1406 may utilize an operating system such as iOS®, ANDROID®, MS-DOS®, MS-WINDOWS®, OS/2®, UNIX®, LINUX®, or another known operating system. In other cases, the I/O controller 1406 may represent or interact with a modem, a keyboard, a mouse, a touchscreen, or a similar device. In some cases, the I/O controller 1406 may be implemented as part of a processor. In some cases, a user may interact with the device 1402 via the I/O controller 1406 or via hardware components controlled by the I/O controller 1406.

The database controller 1408 may manage data storage and processing in a database 1414. In some cases, a user may interact with the database controller 1408. In other cases, the database controller 1408 may operate automatically without user interaction. The database 1414 may be an example of a single database, a distributed database, multiple distributed databases, a data store, a data lake, or an emergency backup database.

Memory 1410 may include random-access memory (RAM) and read-only memory (ROM). The memory 1410 may store computer-readable, computer-executable software including instructions that, when executed, cause the processor to perform various functions described herein. In some cases, the memory 1410 may contain, among other things, a basic input/output system (BIOS) which may control basic hardware or software operation such as the interaction with peripheral components or devices.

The processor 1412 may include an intelligent hardware device, (e.g., a general-purpose processor, a DSP, a central processing unit (CPU), a microcontroller, an ASIC, an FPGA, a programable logic device, a discrete gate or transistor logic component, a discrete hardware component, or any combination thereof). In some cases, the processor 1412 may be configured to operate a memory array using a memory controller. In other cases, a memory controller may be integrated into the processor 1412. The processor 1412 may be configured to execute computer-readable instructions stored in a memory 1410 to perform various functions (e.g., functions or tasks for synchronizing online gaming with secure transactions and real-time request management).

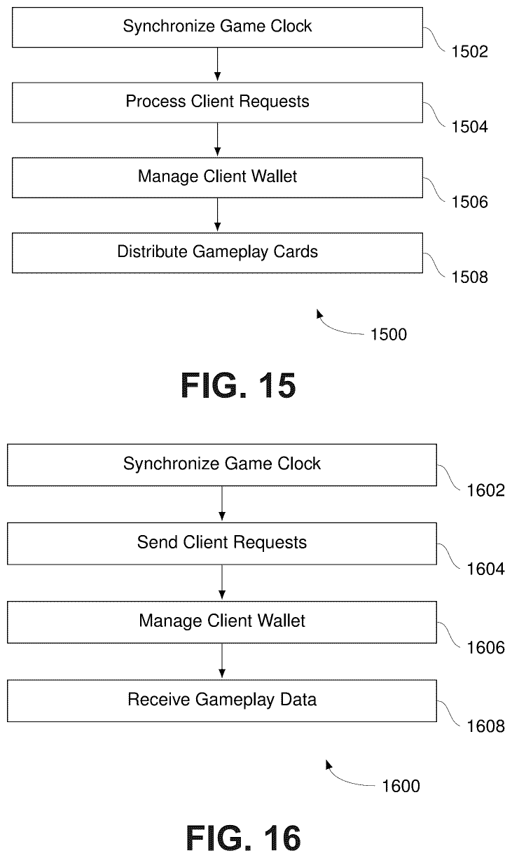

FIG. 15 shows a flowchart illustrating a method 1500 for synchronizing online gaming with secure transactions and real-time request management in accordance with various aspects of the present disclosure. The operations of the method 1500 may be implemented by one or more components of a networked computing system as described herein. For example, the operations of the method 1500 may be performed by secure gaming management component 1404 or through execution of machine-readable instructions 106 as described with reference to FIG. 14 and FIG. 1, respectively. In some examples, one or more components of a networked computing system may execute a set of instructions to control the functional elements of the component(s) to perform the described functions. Additionally or alternatively, the one or more components of a networked computing system may perform aspects of the described functions using special-purpose hardware.

At 1502, the method 1500 may include synchronizing a game clock of a client device with a server clock by performing a ping-pong process to compute round-trip time and adjust timestamps for client requests. The operations of 1502 may be performed in accordance with examples as disclosed herein. In some examples, aspects of the operations of 1502 may be performed by a clock synchronization component 108 as described with reference to FIG. 1.

At 1504, the method 1500 may include processing client requests by validating adjusted timestamps, queuing the requests based on a first-come, first-served principle, and prioritizing the requests in real-time according to the adjusted timestamps. The operations of 1504 may be performed in accordance with examples as disclosed herein. In some examples, aspects of the operations of 1504 may be performed by a request processing component 110 as described with reference to FIG. 1.

At 1506, the method 1500 may include managing a wallet associated with a client by pre-allocating funds for a game session, updating the wallet based on game outcomes, and recording transactions in an unalterable ledger. The operations of 1506 may be performed in accordance with examples as disclosed herein. In some examples, aspects of the operations of 1506 may be performed by a wallet management component 112 as described with reference to FIG. 1.

At 1508, the method 1500 may include distributing cards for gameplay by generating random numbers through a cryptographically secure random number generator and updating game states based on distributed cards. The operations of 1508 may be performed in accordance with examples as disclosed herein. In some examples, aspects of the operations of 1508 may be performed by a card distribution component 114 as described with reference to FIG. 1.

FIG. 16 shows a flowchart illustrating a method 1600 for synchronizing online gaming with secure transactions and real-time request management in accordance with various aspects of the present disclosure. The operations of the method 1600 may be implemented by one or more components of a networked computing system as described herein. For example, the operations of the method 1600 may be performed by secure gaming management component 1404 or through execution of machine-readable instructions 106 as described with reference to FIG. 14 and FIG. 1, respectively. In some examples, one or more components of a networked computing system may execute a set of instructions to control the functional elements of the component(s) to perform the described functions. Additionally or alternatively, the one or more components of a networked computing system may perform aspects of the described functions using special-purpose hardware.

At 1602, the method 1600 may include synchronizing a game clock of a client device with a server clock by receiving synchronization data from the server, computing round-trip time, and adjusting the client game clock based on the synchronization data. The operations of 1602 may be performed in accordance with examples as disclosed herein. In some examples, aspects of the operations of 1602 may be performed by a clock synchronization component 108 as described with reference to FIG. 1.

At 1604, the method 1600 may include sending client requests to the server, the requests being timestamped using the adjusted client game clock, and transmitting the requests for processing in real-time. The operations of 1604 may be performed in accordance with examples as disclosed herein. In some examples, aspects of the operations of 1604 may be performed by a request processing component 110 as described with reference to FIG. 1.

At 1606, the method 1600 may include managing a wallet associated with the client by initiating pre-allocation of funds for a game session, monitoring wallet updates based on game outcomes, and verifying transaction records stored in an unalterable ledger. The operations of 1606 may be performed in accordance with examples as disclosed herein. In some examples, aspects of the operations of 1606 may be performed by a wallet management component 112 as described with reference to FIG. 1.

At 1608, the method 1600 may include receiving gameplay data from the server, including card distribution results generated by a cryptographically secure random number generator, and updating the client game state based on the received gameplay data. The operations of 1608 may be performed in accordance with examples as disclosed herein. In some examples, aspects of the operations of 1608 may be performed by a card distribution component 114 as described with reference to FIG. 1.

It should be noted that the methods described herein describe possible implementations, and that the operations and the steps may be rearranged or otherwise modified and that other implementations are possible. Furthermore, aspects from two or more of the methods may be combined.

Aspect 1: A method for online gaming a wager accumulation game with multiple rounds, with secure transactions and real-time request management, between a client device and a server, the client device comprising a parameterized animation bank, comprising: the client device sending a request among joining, exiting and partnering requests to the server; synchronizing a game clock of the client device with a server clock by performing a ping-pong process to compute round-trip time and adjust timestamps for client requests; the client device timestamping the request by a time provided by the game clock; timestamping the request by an adjusted timestamp corrected by round-trip time upon receipt by the server; processing requests by validating adjusted timestamps, queuing the requests based on a first-come, first-served principle, and prioritizing the requests in real-time according to the adjusted timestamps; managing a wallet associated with a client by putting on hold pre-allocated funds for a game session, updating the wallet based on game outcomes, and recording transactions in an unalterable ledger; distributing card for one of the multiple rounds from a virtual card deck comprising X build cards and H half pot cards by generating random numbers through a cryptographically secure random number generator and updating a game state based on distributed cards; generating animation parameters and distributing the animation parameters to the client device for rendering game animations locally by transmitting data strings representing a card distribution sequence and round outcomes; and rendering an animation on the client device by selecting a parameterized animation from the parameterized animation bank and playing the parameterized animation according to the animation parameters.

Aspect 2: The method of aspect 1, further comprising determining a threshold for triggering an advantage play indicator by comparing a ratio of accumulated wagers to a standard wager with a predefined value based on a composition of the virtual card deck; wherein the server transmits a notification to the client device in response to detecting that accumulated wagers exceed the threshold.

Aspect 3: The method of any of aspects 1 through 2, further comprising further comprising managing a queue of requests by assigning adjusted timestamps to the requests, sorting the requests in chronological order, and processing the requests sequentially during a predefined time window.

Aspect 4: The method of any of aspects 1 through 3, handling a client disconnection by continuing the wager accumulation game with the pre-allocated funds, updating game states on the server, and crediting or debiting the wallet based on game results.

Aspect 5: The method of any of aspects 1 through 4, further comprising enabling a client to join an ongoing game by placing a catch-up wager equal to missed wagers from prior rounds and updating the game state to include the client as an active participant.

Aspect 6: The method of any of aspects 1 through 5, wherein the server updates a game state to reflect a partnership between two clients in response to a partnering request received during a predefined time window.

Aspect 7: A system for online gaming a wager accumulation game with secure transactions and real-time request management, comprising a processor; memory coupled with the processor; and instructions stored in the memory and executable by the processor to cause the system to perform a method of any of aspects 1 through 6.

Aspect 8: A non-transitory computer-readable medium storing code for online gaming a wager accumulation game with secure transactions and real-time request management, the code comprising instructions executable by a processor to perform a method of any of aspects 1 through 6.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, an FPGA or other programable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for online gaming a wager accumulation game with multiple rounds, with secure transactions and real-time request management, between a client device and a server, the client device comprising a parameterized animation bank, comprising:
the client device sending a request among joining, exiting and partnering requests to the server;
synchronizing a game clock of the client device with a server clock by performing a ping-pong process to compute round-trip time and adjust timestamps for client requests;
the client device timestamping the request by a time provided by the game clock;
timestamping requests by an adjusted timestamp corrected by round-trip time upon receipt by the server;
processing the request by validating adjusted timestamps, queuing the requests based on a first-come, first-served principle, and prioritizing the requests in real-time according to the adjusted timestamps;
managing a wallet associated with a client, by putting on hold pre-allocated funds for a game session, updating the wallet based on game outcomes, and recording transactions in an unalterable ledger;
distributing card for one of the multiple rounds from a virtual card deck comprising X build cards and H half pot cards by generating random numbers through a cryptographically secure random number generator and updating a game state based on distributed cards;
generating animation parameters and distributing the animation parameters to the client device for rendering game animations locally by transmitting data strings defining a card distribution sequence and round outcomes; and
rendering an animation on the client device by selecting a parameterized animation from the parameterized animation bank and playing the parameterized animation according to the animation parameters.

2. The method of claim 1, further comprising determining a threshold for triggering an advantage play indicator by comparing a ratio of accumulated wagers to a standard wager with a predefined value based on a composition of the virtual card deck;
wherein the server transmits a notification to the client device in response to detecting that accumulated wagers exceed the threshold.

3. The method of claim 1, further comprising managing a queue of requests by assigning adjusted timestamps to the requests, sorting the requests in chronological order, and processing the requests sequentially during a predefined time window.

4. The method of claim 1, further comprising handling a client disconnection by continuing the wager accumulation game with the pre-allocated funds, updating game states on the server, and crediting or debiting the wallet based on game results.

5. The method of claim 1, further comprising enabling the client to join an ongoing game by placing a catch-up wager equal to missed wagers from prior rounds and updating the game state to include the client as an active participant.

6. The method of claim 1, wherein the server updates the game state to reflect a partnership between two clients in response to a partnering request received during a predefined time window.

7. A system configured for online gaming a wager accumulation game with secure transactions and real-time request management, comprising:
a processor;
memory coupled with the processor;
instructions stored in the memory and executable by the processor to cause the system to:
synchronize a game clock of a client device with a server clock of a server by performing a ping-pong process to compute round-trip time and adjust timestamps for client requests;
process the client requests by validating adjusted timestamps, queuing the client requests based on a first-come, first-served principle, and prioritizing the client requests in real-time according to the adjusted timestamps;
manage a wallet associated with a client by pre-allocating funds for a game session, updating the wallet based on game outcomes, and recording transactions in an unalterable ledger; and
distribute cards for gameplay by generating random numbers through a cryptographically secure random number generator and updating a game state based on distributed cards.

8. The system of claim 7, wherein the instructions are further executable by the processor to cause the system to determine a threshold for triggering an advantage play indicator by comparing a ratio of accumulated wagers to a standard wager with a predefined value based on a composition of a card deck used in the wager accumulation game.

9. The system of claim 7, wherein the instructions are further executable by the processor to cause the system to manage a queue of client requests at a table level by assigning adjusted timestamps to the client requests, sorting the client requests in chronological order, and processing the client requests sequentially during a predefined time window.

10. The system of claim 7, wherein the instructions are further executable by the processor to cause the system to distribute animation parameters to the client device for rendering game animations locally by transmitting data strings representing card distribution sequences and round outcomes.

11. The system of claim 7, wherein the instructions are further executable by the processor to cause the system to handle a client disconnection by continuing the wager accumulation game with pre-allocated funds, updating the game state on the server, and crediting or debiting the wallet based on game results.

12. The system of claim 7, wherein the instructions are further executable by the processor to cause the system to enable the client to join an ongoing game by placing a catch-up wager equal to missed wagers from prior rounds and updating the game state to include the client as an active participant.

13. The system of claim 7, wherein the instructions are further executable by the processor to cause the system to update the game state to reflect a partnership between two clients in response to a partnering request received during a predefined time window.

14. A non-transitory computer-readable medium storing code for online gaming a wager accumulation game with secure transactions and real-time request management, the code comprising instructions executable by a processor to:
synchronize a game clock of a client device with a server clock by performing a ping-pong process to compute round-trip time and adjust timestamps for client requests;
process client requests by validating adjusted timestamps, queuing the client requests based on a first-come, first-served principle, and prioritizing the client requests in real-time according to the adjusted timestamps;
manage a wallet associated with a client by pre-allocating funds for a game session, updating the wallet based on game outcomes, and recording transactions in an unalterable ledger; and
distribute cards for gameplay by generating random numbers through a cryptographically secure random number generator and updating game states based on distributed cards.
